(19) United States
(12) Patent Application Publication
(10) Pub. No.: US 2026/0039416 A1
(43) Pub. Date: Feb. 5, 2026

(54) SYSTEMS AND METHODS FOR ONLINE LEARNING OF JOINT RECEIVER FUNCTIONS FOR DEMODULATION

(71) Applicant: InterDigital Patent Holdings, Inc., Wilmington, DE (US)

(72) Inventors: Asil Koc, Verdun (CA); Philip Pietraski, Jericho, NY (US); Guodong Zhang, Woodbury, NY (US); Mohamed Amine Arfaoui, Montreal (CA); John Kaewell, Jamison, PA (US)

(73) Assignee: InterDigital Patent Holdings, Inc., Wilmington, DE (US)

(21) Appl. No.: 18/790,751

(22) Filed: Jul. 31, 2024

(51) Int. Cl. H04L 1/00; G06N 20/00

(52) U.S. Cl. CPC H04L 1/0061; G06N 20/00

(57) ABSTRACT

A wireless transmit/receive unit (WTRU) may receive configuration information. The configuration information may include an indication of a first receiver function training allocation type, a second receiver function training allocation type, or a third receiver function training allocation type. The first receiver allocation type may be associated with user data allocations. The second receiver training allocation type may be associated with pseudo-random data (PRD) allocations. The third receiver training allocation type may be associated with user data allocations and PRD allocations. The WTRU may generate labels including one or more of bits and/or symbols, for example based on the receiver function training allocation type. The WTRU may train an artificial intelligence/machine learning (AI/ML)-based joint receiver function.

### BACKGROUND

Artificial intelligence (AI) may include behavior exhibited by machines that mimic cognitive functions to sense, reason, adapt and/or act. An AI component may refer to the realization of behaviors and/or conformance to requirements by learning based on data, for example without explicit configuration of sequence of steps of actions. An AI component may enable learning complex behaviors which, for example may be difficult to specify and/or implement when using legacy methods.

Coherent demodulation of signals transmitted over the radio interface may utilize knowledge of the effective (e.g., precoded) wireless channel. The channel estimation process at the receiver in NR may utilize the transmission of physical channels accompanied with demodulation reference signals (DMRS).

### SUMMARY

A wireless transmit/receive unit (WTRU) may receive configuration information. The configuration information may include an indication of a first receiver function training allocation type, a second receiver function training allocation type, or a third receiver function training allocation type. The first receiver allocation type may be associated with user data allocations. The second receiver training allocation type may be associated with pseudo-random data (PRD) allocations. The third receiver training allocation type may be associated with user data allocations and PRD allocations.

The WTRU may receive a downlink (DL) transmission (e.g., from a network). The DL transmission may include one or more of data allocations and/or PRD allocations. The WTRU may generate labels, for example based on the DL transmission. The configuration information may include the first receiver function training allocation type. The labels may be generated by using the received data associated with the data allocations, for example for the first receiver function training allocation type. The configuration information may include the second receiver function training allocation type. The labels may be generated by using the received PRD associated with PRD allocations, for example for the second receiver function training allocation type. The labels may be generated using the received data associated with (e.g., scheduled by) the data allocations and the received PRD associated with (e.g., scheduled by) the PRD allocations, for example for the third receiver function training allocation type.

The WTRU may send a request for online training, for example of an artificial intelligence/machine learning (AI/ML)-based joint receiver function. The request may include a capability associated with the WTRU. The capability may be associated with label generation.

The WTRU may generate labels including one or more of bits (e.g., hard bits) and/or symbols, for example when the configuration information comprises the first receiver function training allocation type. The WTRU may determine if there is an error in a cyclic redundancy check (CRC). The WTRU may generate labels (e.g., bits), for example based on there being no error in the CRC. The labels may be for the decoded data allocated for AI/ML training. The WTRU may generate labels (e.g., bits) by re-encoding the information bits. The WTRU may generate labels by re-encoding decoded bits (e.g., data bits), for example using the same channel coding scheme and/or coding rate as the received data allocated for AI/ML training.

The WTRU may generate labels including one or more of bits and/or symbols, for example when the configuration information comprises the second receiver function training allocation type. The WTRU may generate labels (e.g., bits and/or symbols) based on the PRD allocations and/or on an indication of a seed of PRDs. The WTRU may generate the labels using a PRD generator. The seed of the PRDs may be sent by a network to the WTRU.

The WTRU may generate labels including one or more of bits and/or symbols, for example when the configuration information comprises the third receiver function training allocation type. The WTRU may generate the labels based on the seed associated with the PRD allocations and by re-encoding decoded bits in the data channel associated with the data allocations.

The WTRU may train an artificial intelligence/machine learning (AI/ML)-based joint receiver function, for example based on the (e.g., generated) labels. The WTRU may (e.g., then) transmit a training status message to the network. The WTRU may use the status message to transmit an indication that training is complete to the network, for example based on the training of the AI/ML-based joint receiver function. The data allocations may include data resource elements (REs). The PRD allocations may include PRD REs. The WTRU may store a dataset (e.g., received resource elements and/or labels) in a memory. The dataset may be used for training.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example NR DMRS Structure with configuration type 1 for ports 1000-1003.

FIG. 3 is an example NR DMRS structure with configuration type 2 for ports 1000-1003.

FIG. 4 is an example of DMRS-based channel estimation, equalization, demodulation, and channel decoding.

FIG. 5 illustrates an example AI/ML model architecture for the joint channel estimator, equalizer, and demodulator.

FIG. 6 illustrates the example receiver function training allocations.

FIG. 7 shows type 1 examples of an AI/ML-based joint channel estimator, equalizer, and demodulator; and an AI/ML-based joint channel estimator and equalizer.

FIG. 8 shows type 2 examples of an AI/ML-based joint channel estimator, equalizer, and demodulator; and an AI/ML-based joint channel estimator and equalizer.

FIG. 9 is an example of AI/ML model training.

FIG. 10 shows example DMRS densities.

FIG. 11 is an example plot of throughput performance versus SNR.

FIG. 12 shows example BLER performance versus SNR.

FIG. 13 shows example throughput performance versus SNR.

### DETAILED DESCRIPTION

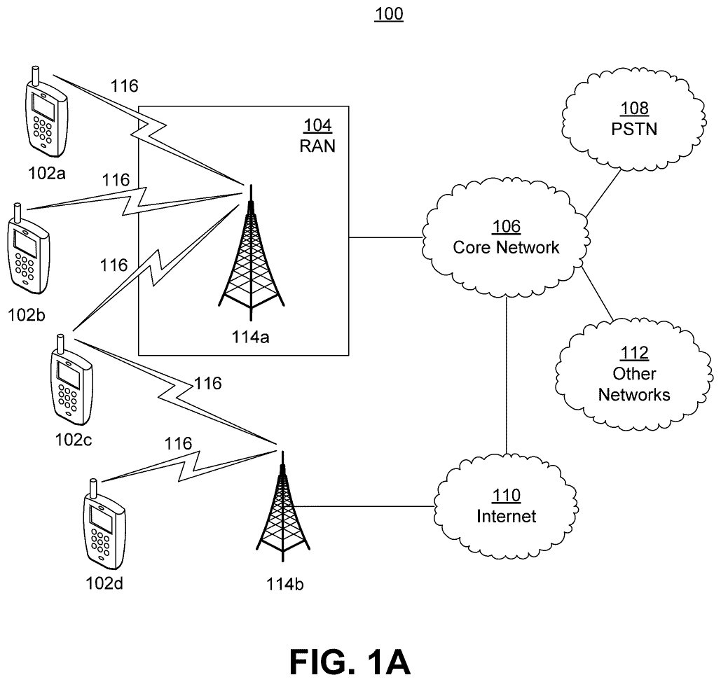

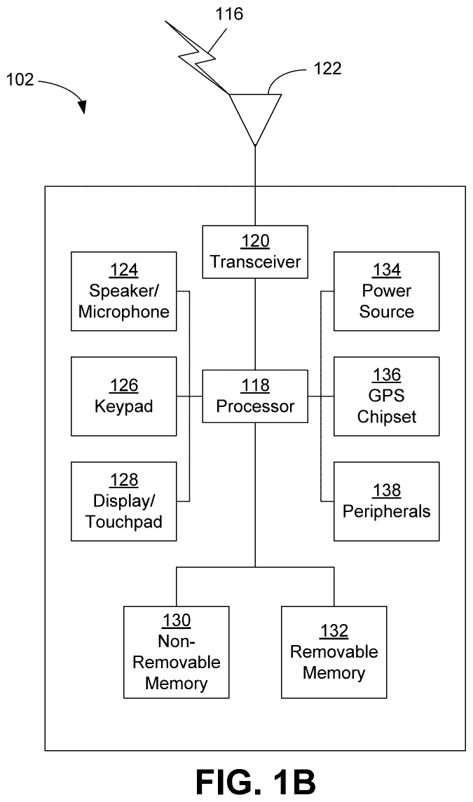

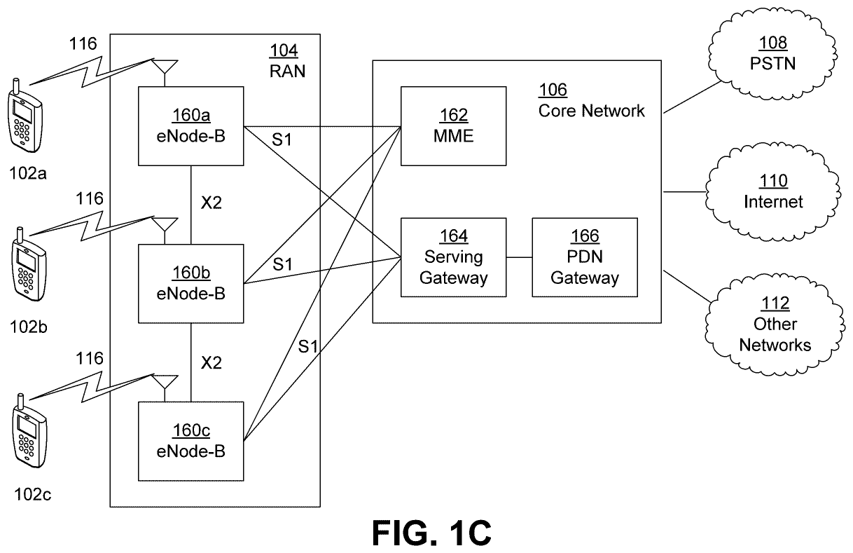

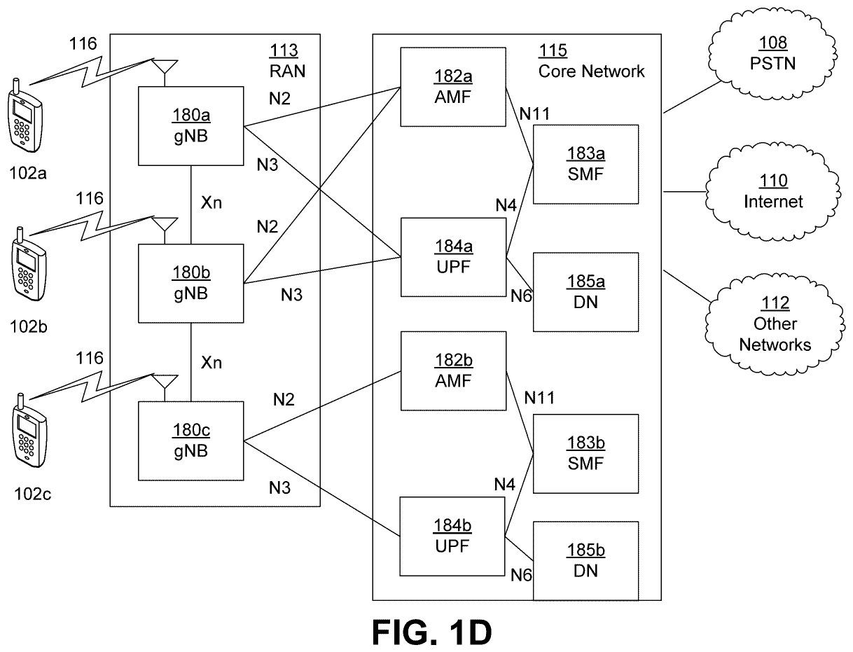

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), Single-Carrier Frequency Domain Equalization (SC-FDE), DFT-s-OFDM, resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement a radio technology such as 6G Radio Access, which may establish the air interface 116 using 6G standards.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may receive configuration information. The configuration information may include an indication of a first receiver function training allocation type, a second receiver function training allocation type, or a third receiver function training allocation type. The first receiver allocation type may be associated with user data allocations. The second receiver training allocation type may be associated with pseudo-random data (PRD) allocations. The third receiver training allocation type may be associated with user data allocations and PRD allocations. The first receiver function training allocation type may correspond to type 1, the second receiver function training allocation type may correspond to type 2, and/or the third receiver function training allocation type may correspond to type 3.

The WTRU may receive a downlink (DL) transmission (e.g., from a network). The DL transmission may include one or more of data, data allocations, PRDs, and/or PRD allocations. The data allocations and/or PRD allocations may be received via PDCCH. Data and PRD may be received via PDSCH. The WTRU may generate labels, for example based on the DL transmission (e.g., data and/or PRDs in the DL transmission). The terms labels and high-quality labels may be used interchangeably herein. The configuration information may include the first receiver function training allocation type. The labels may be generated by using the received data associated with the data allocations, for example for the first receiver function training allocation type. The configuration information may include the second receiver function training allocation type. The labels may be generated by using the received pseudo-random data associated with the pseudo-random data allocations, for example for the second receiver function training allocation type. The labels may be generated using the received data associated with the data allocations and the received PRD associated with the PRD allocations, for example for the third receiver function training allocation type. Additionally, or alternatively, the labels may be generated using one or more of data and/or PRDs. The data and/or PRDs may be received, for example from the network (e.g., in the DL transmission).

The WTRU may send a request for online training, for example of an artificial intelligence/machine learning (AI/ML)-based joint receiver function. The request may include a report of a capability associated with the WTRU. The capability may be associated with label generation.

The WTRU may generate labels including one or more of bits (e.g., hard bits) and/or symbols, for example when the configuration information comprises the first receiver function training allocation type. The WTRU may determine if there is an error in a cyclic redundancy check (CRC). The WTRU may generate labels (e.g., bits), for example based on there being no error in the CRC. The labels may be for the decoded data allocated for AI/ML training. The WTRU may generate labels (e.g., bits) by re-encoding the information bits, for example using the same channel coding scheme and/or coding rate as the received data allocated for AI/ML training. The WTRU may generate labels (e.g., symbols) by re-encoding and/or re-modulating the information bits.

The WTRU may generate labels including one or more of bits and/or symbols, for example when the configuration information comprises the second receiver function training allocation type. The WTRU may generate labels (e.g., bits and/or symbols) based on the PRD allocations and/or on an indication of a seed of PRDs. The WTRU may generate the labels (e.g., bits) using a PRD generator. The seed of the PRDs may be sent by a network to the WTRU.

The WTRU may generate labels including one or more of bits (e.g., hard bits) and/or symbols, for example when the configuration information comprises the third receiver function allocation type. The WTRU may determine if there is an error in a CRC. The WTRU may generate labels, for example if there is no error in the CRC. The WTRU may generate labels (e.g., bits and/or symbols) based on the PRD allocations and/or on an indication of a seed of PRDs. The WTRU may generate the labels (e.g., bits) using a PRD generator. The seed of the PRDs may be sent by a network to the WTRU. The WTRU may generate the labels based on the seed associated with the PRD allocations and by re-encoding decoded bits associated with the data allocations.

The WTRU may train an artificial intelligence/machine learning (AI/ML)-based joint receiver function, for example based on the (e.g., generated) labels. The WTRU may (e.g., then) transmit a training status message to the network. The WTRU may use the training status message to transmit an indication that training is complete (e.g., or not complete) to the network, for example based on the training of the AI/ML-based joint receiver function. The data allocations may include data resource elements (REs). The PRD allocations may include PRD REs. The WTRU may store a dataset (e.g., received resource elements and/or labels) in a memory, for example to be used for training.

A receiver may be a WTRU and/or a network, for example a network entity. The receiver may be for demodulation. The receiver may have multiple function blocks. Function blocks may be (e.g., each) separately optimized, for example based on intermediate key performance indicators (KPIs). Segmentation, for example by using multiple function blocks and/or separate optimization, may prevent maximized (e.g., potential) performance. Artificial intelligence/machine learning (AI/ML) may be used to improve individual receiver functions and/or replace groups of functions with jointly optimized algorithms. However, systems and methods that enable customized and/or online learning optimization would be beneficial. Systems and methods for one or more of requesting training, admitting training, controlling training, terminating training, monitoring performance, balancing training overhead with user data, and/or defining fallback mechanisms may be provided, for example for each supported combination on multi-block chaining.

A WTRU may request online training, for example of AI/ML-based joint receiver functions. The WTRU may be configured with a target model loss and/or data performance metric, for example such that the WTRU may detect whether the training is sufficient. The WTRU may be configured with the target model loss and/or data performance metric through DCI and/or MAC-CE.

The WTRU may be configured with type 1, type 2, or type 3 receiver function training allocations, for example through DCI and/or MAC-CE. The WTRU may generate high-quality labels, for example by using type 1, type 2, or type 3 receiver function training allocations and/or a DL transmission (e.g., including one or more of data and/or PRDs). Additionally, or alternatively, the WTRU may use the high-quality labels to train joint receiver functions, for example AI/ML-based joint receiver functions. The WTRU may send a message indicating that training is complete, for example when the WTRU determines/detects that training is sufficient. The WTRU may send the message indicating that training is complete to a base station (e.g., gNB), for example via UCI and/or MAC-CE. The WTRU may be configured and/or triggered to apply data performance monitoring, for example of AI/ML-based joint receiver functions. The WTRU may apply data performance monitoring by comparing the WTRU data performance to non-AI/ML receiver functions. The non-AI/ML receiver functions may be legacy receiver functions.

Systems and methods for a WTRU to enable online learning of the joint receiver functions for demodulation are provided herein, for example for systems using AI/ML models in the receiver functions for demodulation (e.g., channel estimation for demodulation, equalizer, demodulator).

Artificial intelligence (AI) may include behavior exhibited by machines that, for example may mimic cognitive functions to sense, reason, adapt, and/or act. An AI component may include the realization of behaviors and/or conformance to requirements by learning based on data, for example without explicit configuration of sequence of steps of actions. An AI component may enable learning complex behaviors. Complex behaviors may be difficult to specify and/or implement when using legacy methods.

Machine learning (ML) may include algorithms (e.g., types of algorithms) that solve a problem based on learning through experience (e.g., data), for example without being explicitly programmed (e.g., configuring a set of rules). ML may be a subset of AI. Different ML paradigms may be envisioned, for example based on the nature of data or feedback available to the learning algorithm. A supervised learning approach may involve learning a function that maps input to an output based on labeled training example. A (e.g., each) training example may include a pair. The pair may include an input and a corresponding output. An unsupervised learning approach may involve detecting patterns in the data with no pre-existing labels. A reinforcement learning approach may involve performing sequence of actions in an environment, for example to maximize the cumulative reward. ML algorithms may be applied using a combination and/or interpolation of the approaches herein. For example, a semi-supervised learning approach may use a combination of a small amount of labeled data with a large amount of unlabeled data during training. Semi-supervised learning may fall between unsupervised learning (e.g., with no labeled training data) and supervised learning (e.g., with only labeled training data).

Deep learning may include a class of ML algorithms that may employ artificial neural networks, for example Deep Neural Networks (DNNs). DNNs may be (e.g., loosely) inspired by biological systems. The DNNs may be a special class of ML models that may be inspired by the human brain. The input may be linearly transformed and/or pass through non-linear activation function multiple times. DNNs may include multiple layers. A (e.g., each) layer may include a linear transformation and/or a given non-linear activation function. The DNNs may be trained using the training data, for example via back-propagation algorithm. DNNs may be utilized in a variety of domains including, for example speech, vision, natural language, wireless communication, and/or etc., and/or for (e.g., various) ML settings, for example supervised, un-supervised, semi-supervised, and/or etc.

A demodulation reference signal (DMRS) may be utilized. Coherent demodulation of signals transmitted over the radio interface may utilize knowledge of the effective (e.g., precoded) wireless channel. The channel estimation process at the receiver in NR may utilize the transmission of physical channels accompanied with demodulation reference signals (DMRS). DMRSs may be generated using pseudo-random sequences, for example based on systems parameters known to the receiver. The parameters used to control the sequence generation may include scrambling identity, symbol locations, number of OFDM symbols in a slot, and/or etc. The DMRS operation in NR may include (e.g., several) predefined options for patterns (e.g., uniform/equally spaced) and/or densities of RSs based on one or more of the physical channels, which for example may be configured using scheduling (e.g., DCI-based) and/or high-layer configuration to cater for different use cases and WTRU capabilities.

The configuration of the DMRS may include a density and/or pattern in the resource grid, a duration, a starting symbol (e.g., front-loaded DMRS), and/or cover code(s), for example to differentiate between antenna ports sharing the same time/frequency resources (e.g, for single-user and multi-user MIMO cases). The set of parameters for DMRS may be different depending on the physical channel and/or depending on WTRU capability. For example, for PDSCH DMRS, there may be configuration type 1 or type 2, mapping type A or type B, starting symbol for mapping type A, single versus double symbol DMRS, DMRS additional positions, and/or duration.

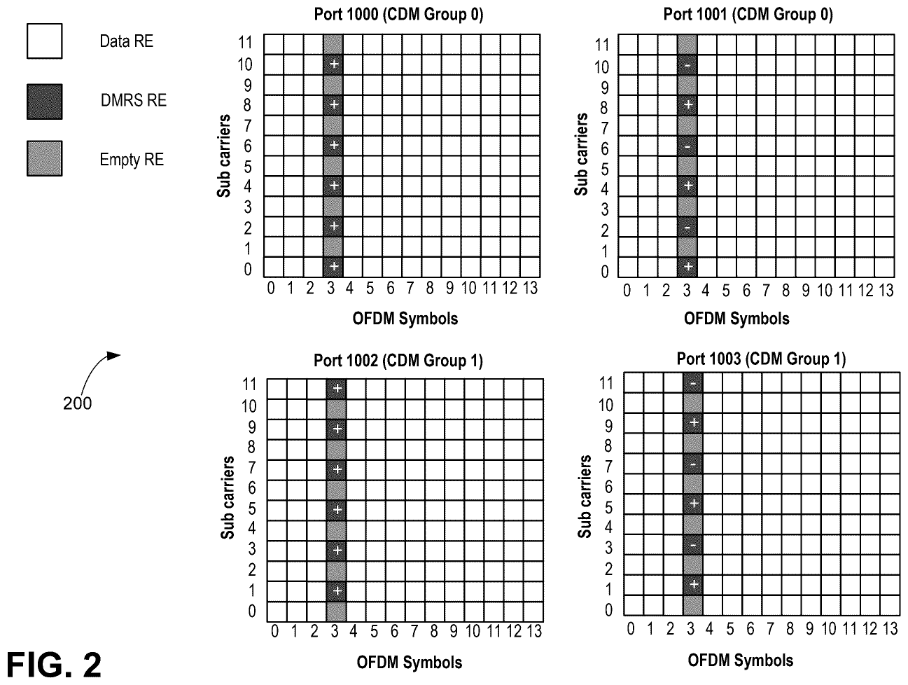

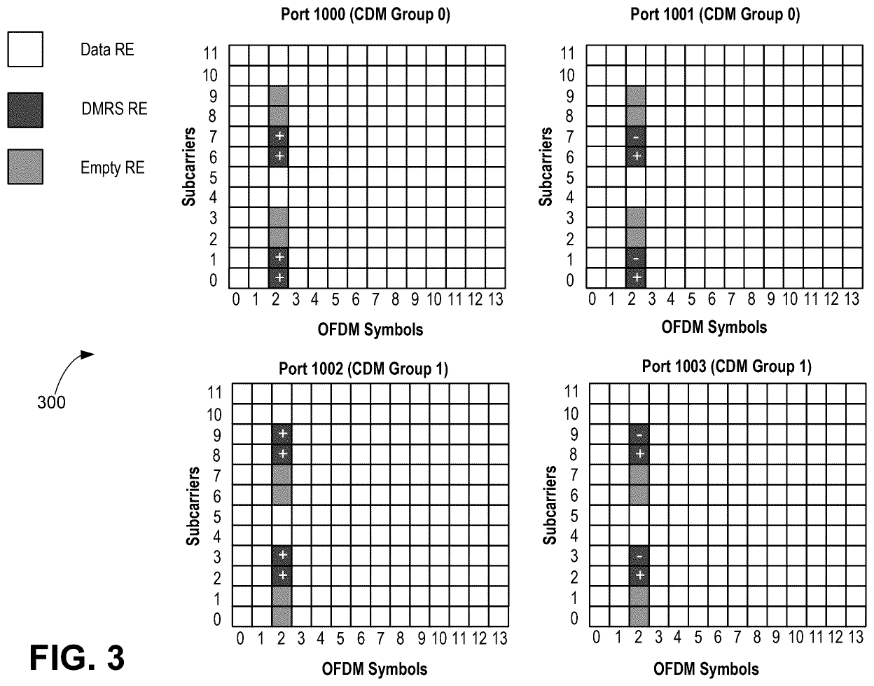

The (e.g., specific) selection of DMRS may be carried out by (e.g., both) higher-layer configuration and/or dynamic (e.g., DCI-based) signaling. Additionally, or alternatively, there may be cases where there is a default configuration in place. The gNB may signal (e.g., using RRC, MAC-CE, and/or PDCCH/DCI) the selection to the terminal, for example upon selection of DMRS settings. FIGS. 2 and 3 show example DMRS patterns over one slot and one resource block in NR with CDM grouping across the frequency and code domains. In FIG. 2, a DMRS pattern 200 follows mapping type A, configuration type 1, and starting symbol 3 using downlink antenna ports 1000-1003. In FIG. 3, a DMRS pattern 300 uses mapping type A, configuration type 2 and starting symbol 2 using downlink antenna ports 1000-1003.

The terminal may (e.g., then) utilize the DMRS for channel estimation and/or coherent demodulation of the corresponding physical channels. This may be achieved through specific receiver filter implementation (e.g., least squares, minimum mean squared error (MMSE), and/or etc.) which, for example may (e.g., broadly) estimate the composite channel. Estimating the composite channel may include mapping the transmitted layers onto the receive antennas, for example for the resource blocks that are scheduled.

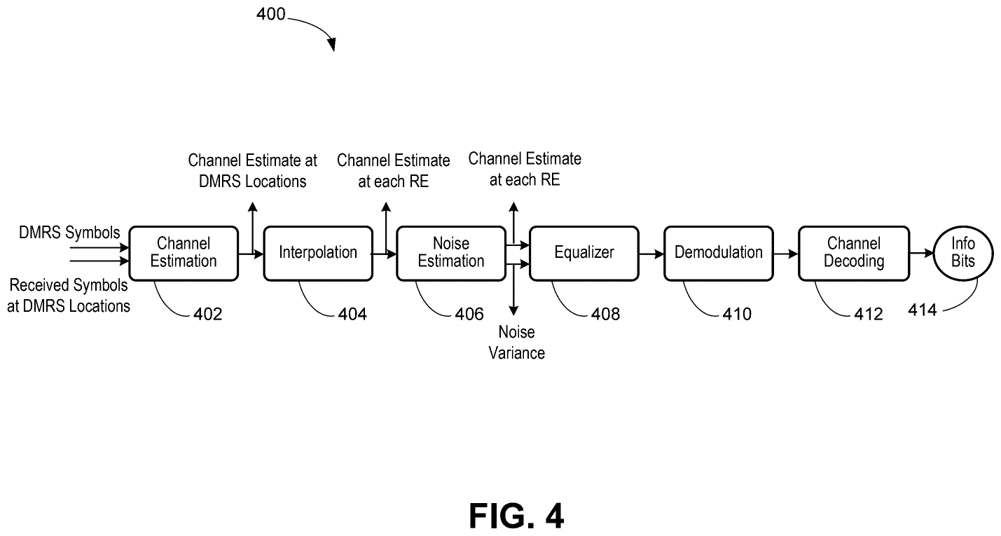

FIG. 4 shows an example channel estimation process 400. At 402 the receiver may (e.g., first) determine the channel estimate(s) of the DMRS symbol(s), for example from their known locations in the received slots. An averaging window may be used to minimize the effects of noise. At 404 multi-dimensional interpolation operations may (e.g., then) be used, for example to estimate the missing values associated with (e.g., all) the other REs from the channel estimation grid. At 406 noise power estimation and/or Doppler estimation may be performed, for example to improve performance by comparison of direct and average channel estimates. Based on the channel and/or noise estimates for example, at 408 the terminal may (e.g., then) design an equalizer (e.g., MMSE). At 410, the terminal may (e.g., then) perform coherent demodulation and/or channel decoding, for example based on channel and/or noise estimates. Information bits may be output at 414.

Conventional receiver function performance may (e.g., heavily) depend on DMRS density. High DMRS overhead may be desired for adequate system KPI, which may for example lead to lower spectral efficiency. DMRS overhead may scale with MIMO order.

A receiver for demodulation may include multiple function blocks (i.e., channel estimator, equalizer, demodulator). A function block (e.g., each function block) may be separately optimized, for example based on intermediate KPIs. Segmented optimization may prevent maximum (e.g., potential) performance. For example, there may be suboptimal overall system efficiency and/or effectiveness compared to a theoretically ideal/jointly optimized receiver architecture.

AI/ML may be used to improve individual receiver functions and/or replace groups of functions with jointly optimized algorithms. However, offline learning of receiver functions may not adapt well to one or more of the environment, the radio impairments, and/or dynamic conditions (e.g., channel types, WTRU mobility, and/or link conditions (RSRP, RSRQ, SINR, etc.), QoS requirements). An offline training dataset may be obtained, for example from a handful of available/agreed channel models. The offline training dataset may be limited to a particular set of environments and/or conditions, for example without including hardware impairments. Radio impairments for each device may be different and/or may change over time and/or with other environmental factors.

Systems and methods that enable customized and/or continuing (e.g., online) learning optimization for each receiver and/or environment would be beneficial. For example, systems and methods for collecting labeled data for the different possible subsets of receiver functions would be beneficial. Systems and methods for one or more of requesting training, admitting training, controlling training, terminating training, monitoring performance, balancing training overhead with user data, and/or defining fallback mechanisms may be provided, for example for each supported combination on multi-block chaining.

A WTRU may be configured to utilize AI/ML-based joint receiver functions, for example for demodulation. The WTRU and/or a network (NW) may detect AI/ML model performance degradation. An AI/ML model may experience a performance degradation (e.g., lack of model generalization), for example when the WTRU moves to a new radio environment and/or the link conditions change (e.g., WTRU mobility decreases/increases). AI/ML model may be trained/fine-tuned, for example in response to performance degradation.

Systems and methods are provided herein which allow a WTRU to request, admit, control, and/or terminate the online training of joint receiver functions for demodulation. Online learning of joint receiver functions may improve overall system performance and/or reduce the DMRS overhead size, for example while adapting to one or more of the environment, new link conditions, and/or hardware impairments. Systems and methods herein describe a WTRU training the AI/ML-based joint receiver functions with the assistance of another node in the network (e.g., gNB); the WTRU generating high-quality labels via received DMRS REs, pseudo-random data (PRD) REs, and/or data REs for the AI/ML model training.

The WTRU may be configured by the NW to train the AI/ML-based joint receiver functions with the assistance of another node in the network (e.g., gNB) and/or generate high-quality labels via received DMRS REs, pseudo-random data (PRD) REs, and/or data REs for the AI/ML model training. Modulation constellations may be used, for example during data transmission. The modulation constellations may include one or more of traditional (e.g., Square QAM) and/or arbitrary modulation constellations, for example as AI/ML-based joint receiver functions may be trained/learned for an arbitrary modulation constellation. Configuration may be via RRC and/or MAC-CE signaling, for example.

AI/ML-based joint receiver functions may include one or more receiver functions. For example, AI/ML-based joint receiver functions may include a subset of combinations of receiver functions. Receiver functions may include one or more of channel estimator, equalizer, and/or demodulator.

The WTRU and/or the NW may initiate online training may be initiated. The WTRU and/or the NW may transmit an online training request. For example, the WTRU and/or NW may be triggered and/or detect a need to initiate online learning of AI/ML-based joint receiver functions. The WTRU may request online training of AI/ML-based joint receiver functions by including a (e.g., first) CSI associated with transmission of data and/or pseudo-random data (PRD), for example to be simultaneously used for model training. The WTRU may include a second CSI, for example for transmission not used for training. The request may be made in a CSI report. The request may be made in an independent transmission that includes CSI report, for example through UCI and/or MAC-CE.

A WTRU may request increased diversity of training data, for example a different modulation order (e.g., that are deficient in training data) and/or a different code rate to increase the possibility of cyclic redundancy check (CRC) success. The WTRU may report WTRU capabilities (e.g., capability of generating labels via encoding or re-encoding with forward error correction (FEC), and/or computing capability) and/or dynamic conditions (e.g., WTRU power saving state), for example such that the WTRU may be configured with either type 1, type 2, or type 3 receiver function training allocations (e.g., via DCI or MAC-CE). FEC may include one or more of LDPC, polar, and/or turbo. The WTRU may be configured with a target model loss (e.g., binary cross entropy) and/or data performance metric (e.g., BER, BLER, and/or throughput), for example via DCI and/or MAC-CE (e.g., such that WTRU can detect whether the training is sufficient). The WTRU may receive the corresponding constellation (e.g., via DCI and/or MAC-CE), for example when AI/ML-based joint receiver functions exclude the demodulator and/or (e.g., while) the NW modulates the data symbols via an arbitrary constellation (e.g., non-square QAM).

The WTRU may extract (e.g., verified) information bits of the FEC decoder. A CRC may be attached. The information bits and/or the CRC may be encoded, for example with the same code rate and/or FEC encoder used by the NW, to provide coded bits that can be used to make labels. The WTRU may modulate (e.g., QAM modulate) bits (e.g., using the same modulator as the NW), for example if symbols are used and/or required for labels.

The WTRU may be configured with (e.g., either) type 1, type 2, and/or type 3 receiver function training allocations, for example via DCI and/or MAC-CE. The WTRU may generate high-quality labels via data allocations, for example for type 1. The WTRU may generate the high-quality labels using the received data associated with (e.g., scheduled by) the data allocations, for example for the first receiver function training allocation type (e.g., type 1).

The labels may include hard bits, for example by re-encoding the LDPC output when the CRC check succeeds. The WTRU may not generate labels, for example if the CRC check of the LDPC output fail. The WTRU may (e.g., then) either stores or disregards the corresponding received REs.

The WTRU may generate high-quality labels via PRD allocations, for example for type 2. The WTRU may generate the high-quality labels using the received PRD associated with (e.g., scheduled by) the PRD allocations, for example for the second receiver function training allocation type (e.g., type 2). Labels may include hard bits, for example via PRD generator. The WTRU may be signaled with the seed of PRD generator, for example by the NW. Type 1, type 2, and/or type 3 receiver function training allocations may include (e.g., either) low and/or normal density DMRS allocations.

The WTRU may be configured with type 1 receiver function training allocations. The WTRU may generate the high-quality labels via non-AI/ML (e.g., legacy) receiver functions and/or AI/ML-based joint receiver functions. The WTRU may indicate and/or report whether the corresponding labels were utilized in the model training (e.g., along with hybrid automatic repeat request (HARQ)-acknowledgment (ACK)), for example through UCI and/or MAC-CE. The WTRU may request variable code rate configuration during the model training, for example if the WTRU generates the high-quality labels via AI/ML-based joint receiver functions. The performance of AI/ML-based joint receiver functions may improve during the model training, which for example may increase the probability of CRC success while generating high-quality labels. The WTRU may request an increased code rate (e.g., through UCI and/or MAC-CE), for example for opportunistically increasing the spectral efficiency (e.g., while successfully generating labels).

The WTRU may be configured with type 2 receiver function training allocations. The WTRU may be assigned to a pseudo random data (PRD) group, for example to receive the non-specific receiver training function allocations. The WTRU may be configured with type 3 receiver function training allocations. The WTRU may generate the labels via data (e.g., allocations) and PRD allocations.

The WTRU may train the AI/ML-based joint receiver functions. The WTRU may calculate model loss, for example by comparing the model predictions and high-quality labels. Model input may include one or more of received demodulation reference signal (DMRS) resource elements (REs), data REs, PRD REs, channel state information (CSI)-reference signal (RS) REs, DMRS pilots CSI-RS pilots, RSRP, least square (LS) estimate of effective (e.g., precoded) channel, and/or noise power estimate. Model output may include symbols, effective noise estimates, log-likelihood ratio (LLR), hard bits, and/or DMRS REs. Model inputs may be for one or more of AI/ML-based joint channel estimators, equalizers, and/or demodulators. Symbols may be at data REs and/or DMRS REs, for example for AI/ML-based joint channel estimators and/or equalizers. Effective noise estimates may be for AI/ML-based joint channel estimators and/or equalizers. LLRs (Log-Likelihood Ratio), hard bits (e.g., at data REs), and/or DMRS REs may be for AI/ML-based joint channel estimators, equalizers, and/or demodulators (e.g., or AI/ML-based joint channel estimators and/or demodulators). Hard bit may be at data REs.

The WTRU may save (e.g., store) the dataset (e.g., received DMRS REs, data REs, PRD REs, CSI-RS REs, DMRS pilots CSI-RS pilots, RSRP, LS estimate of effective/precoded channel, noise power estimate, and/or high-quality labels), for example, in a replay buffer. The WTRU may use the replay buffer for a continued model training and/or for the performance monitoring. The WTRU and/or NW may use the replay buffer to create augmented training datasets, for example by permutating (e.g., various aspects of) the datasets. For example the WTRU and/or NW may add noise and/or other channel and/or radio impairment effects (e.g., in combination or separately). The WTRU may share (e.g., send) a saved dataset with the NW. For example, the WTRU may be configured to share the saved dataset with the NW.

The WTRU may sends a message including an indication that training is complete. The message may be sent to a base station (e.g., gNB), for example via uplink control information (UCI) and/or medium access control (MAC)-control element (CE). The WTRU may determine to send the message when the WTRU detects/determines the training is sufficient.

Systems and methods are described for AI/ML model performance monitoring of joint receiver functions. An AI/ML-based joint receiver function may be deployed for online interference. AI/ML model performance monitoring may be at the WTRU and/or the NW. Performance monitoring may enable a WTRU to perform one or more of using (e.g., continue to use) the current (e.g., existing) model, use a non-AI/ML (e.g., legacy) technique for a receiver function, retrain and/or fine-tune the current model (e.g., after performance degradation).

The WTRU may be configured to use an AI/ML model for the joint receiver functions. The model may be trained online and/or offline. The WTRU may be configured and/or triggered to apply data performance monitoring of AI/ML-based joint receiver functions, for example by comparing data performance with non-AI/ML (e.g., legacy) receiver (Rx) functions. An out-of-distribution (OOD) test result may alternatively, or additionally, trigger the WTRU to apply the data performance monitoring. CRC failures may trigger the WTRU to apply the data performance monitoring.

The WTRU may be configured with a single or multiple target data performance metric(s), for example by the NW. A data performance metric may include one or more of BER, BLER, and/or throughput. The target data performance metric may be application specific. The WTRU may be configured to alternate between AI/ML-based joint Rx functions and non-AI/ML (e.g., legacy) receiver functions.

The WTRU may be configured to monitor the historical data performance. The WTRU may be configured to generate the high-quality labels, for example via performance monitoring allocations. The WTRU may be configured to monitor the error between predicted symbols and the corresponding high-quality labels, for example for AI/ML-based joint channel estimator and equalizer. The WTRU may be configured to monitor the error between predicted LLRs or hard bits and the corresponding high-quality labels, for example for AI/ML-based joint channel estimator, equalizer, and/or demodulator (e.g., or AI/ML-based joint channel estimator and demodulator).

The WTRU may determine if there is data performance degradation, for example based on the outcome of the data performance monitoring. For example, performance monitoring data may indicate that the AI/ML-based joint receiver functions perform lower than pre-configured threshold. Additionally, or alternatively, the performance monitoring data may indicate that non-AI/ML (e.g., legacy) receiver functions achieve one or more of a better BER, BLER, and/or throughput performance than the AI/ML-based joint receiver functions.

The WTRU may report performance degradation to the NW (e.g., through UCI or MAC-CE), for example if the WTRU determines there is data performance degradation. The WTRU may request updating/retraining the AI/ML model, for example based on a determination of performance degradation. The WTRU may fall back to non-AI/ML (e.g., legacy) receiver functions, for example based on a determination of performance degradation (e.g., the non-AI/ML (e.g., legacy) receiver functions achieve one or more of a better BER, BLER, and/or throughput performance than the AI/ML-based joint receiver functions).

The WTRU may be configured or triggered to apply an OOD detection mechanism, for example to identify whether the AI/ML model inputs belong to the same distribution as the data used in the AI/ML model training. Data performance monitoring may trigger the WTRU to apply the OOD detection. CRC failures may trigger the WTRU to apply the OOD detection. The WTRU may be configured to use one or more of the received DMRS REs, data REs, CSI-RS REs and/or PRD REs in OOD detection. An OOD detection test result may be binary (e.g., 0 or 1). If the OOD test result is 0 (e.g., in-distribution) for example, the WTRU may continue to use AI/ML-based joint receiver functions. If the OOD test result is 1 (e.g., out-of-distribution) for example, an OOD event may occur.

When a predetermined number of (e.g., N) OOD event(s) occur, for example within a pre-configured period, the WTRU may one or more of be configured to report the OOD event(s) to the NW through the UCI, fall back to non-AI/ML (e.g., legacy) receiver functions, request updating and/or retraining of the AI/ML model, and/or be configured to apply data performance monitoring.

An OOD detection test result may be non-binary, for example a floating-point number in [0,1]. The WTRU may be configured with a single or multiple threshold(s) for OOD test results. The WTRU may continue to use AI/ML-based joint receiver functions, for example if an OOD test result is lower than any thresholds (i.e., in-distribution). The WTRU may be configured to report the OOD event(s) to the NW (e.g., through the UCI) while continuing to use the same AI/ML model, for example if an OOD test result is higher than the first threshold, but lower than the second threshold. An OOD event may occur, for example if an OOD test result is higher than any thresholds (e.g., out-of-distribution). When a predetermined number (e.g., N) OOD event(s) occur, for example within a pre-configured period, the WTRU may one or more of be configured to report the OOD event(s) to the NW (e.g., through the UCI), fall back to non-AI/ML (e.g., legacy) receiver functions, request updating and/or retraining the AI/ML model, be configured to apply the data performance monitoring.

Systems and methods for online learning of joint receiver functions are disclosed. A WTRU and/or a NW may detect an AI/ML model performance degradation, for example when the WTRU is configured to utilize the AI/ML-based joint receiver functions for demodulation. The AI/ML model may experience a performance degradation (e.g., lack of model generalization), for example when the WTRU moves to a new radio environment and/or the link conditions change (e.g., WTRU mobility decreases/increases). There may be AI/ML model training and/or fine-tuning, for example when there is AI/ML model degradation. A WTRU may one or more of request, admit, control, and/or terminate the online training of joint receiver functions for demodulation. Online learning of joint receiver functions may improve the overall system performance and/or reduce the DMRS overhead size, for example while adapting to one or more of the environment, new link conditions, and/or hardware impairments.

A WTRU may be configured (e.g., by the NW) to train the AI/ML-based joint receiver functions, for example with the assistance of another node in the network (e.g., gNB). A WTRU may generate high-quality labels, for example via one or more of received DMRS REs, pseudo-random data (PRD) REs, and/or data REs for the AI/ML model training. Systems and methods may enable utilization of traditional (e.g., Square QAM) and/or arbitrary modulation constellations, for example during the data transmission. AI/ML-based joint receiver functions may be trained/learned for an arbitrary modulation constellation. A configuration may be via RRC and/or MAC-CE signaling.

AI/ML-based receiver functions may include one or more of channel estimator, equalizer, and/or demodulator. For example, a combination may include one or more of channel estimator, equalizer, and demodulator; channel estimator and equalizer; channel estimator and demodulator; equalizer and demodulator; channel estimator; equalizer; and/or demodulator.

There may be AI/ML-based joint receiver functions for demodulation via an AI/ML model. The WTRU may perform the joint receiver functions for demodulation via an AI/ML model. An AI/ML procedure and/or system may include one or more of input data, pre-processing, AI/ML model post-processing, output data, training, inference, and/or performance monitoring. The AI/ML procedure and/or system may be applied to joint receiver functions for demodulation.

The WTRU and/or NW may receive input data. AI/ML model input may include input data. The input data may include one or more of received data REs, received PRD REs, received DMRS REs, received CSI-RS REs, DMRS pilots, CSI-RS pilots, RSRP, and/or noise power estimate. Preprocessing may include one or more of extraction of received data REs, extraction of received PRD REs, extraction of received DMRS RES, reshaping input data shape, and/or concatenation of the real and imaginary parts to obtain a real-valued AI/ML model input. Extraction of the received data REs may be from the received signals, for example using the configured data locations (e.g., allocations). Extraction of the received PRD REs may be from the received signals, for example using configured PRD locations (e.g., allocations). Extraction of the received DMRS REs may be from the received signals, for example using the configured DMRS locations (e.g., allocations). The WTRU may perform division of the received DMRS REs, for example by known DMRS pilots. The WTRU may perform multiplication of the received DMRS REs, for example by conjugate of the known DMRS pilots. The WTRU may apply an interpolation and/or a 2D filtering, for example to the DMRS REs.

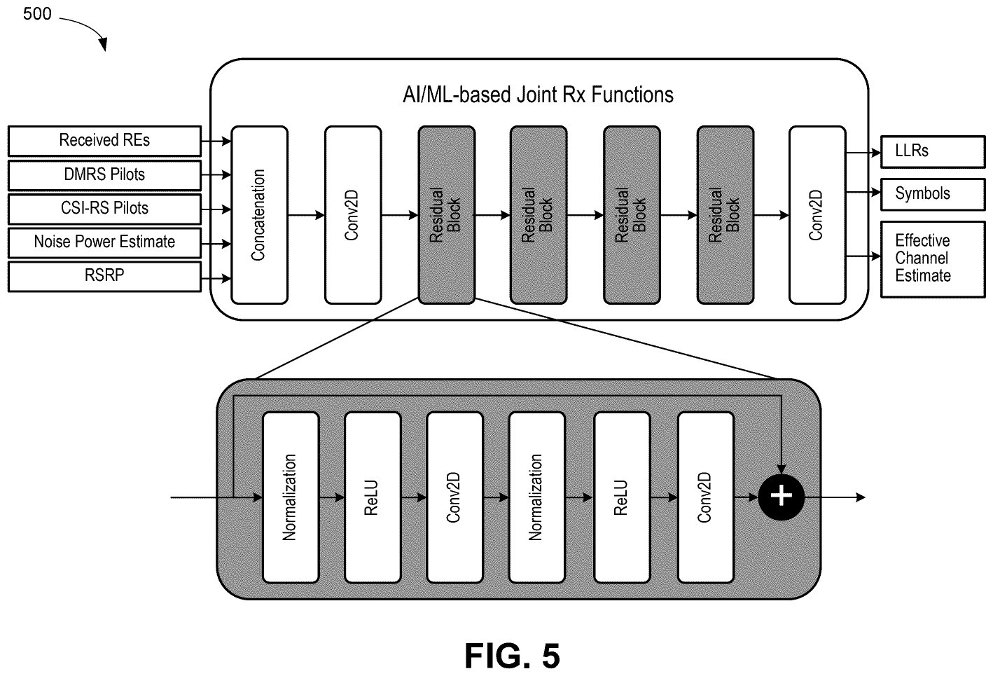

FIG. 5 illustrates an example AI/ML model architecture 500 for the joint channel estimator, equalizer, and demodulator. The WTRU and/or NW may construct the AI/ML model. The AI/M model may be constructed using one or more of concatenation, convolution, layer normalization, rectified linear unit (ReLU) activation layers, and/or residual skip connections. The AI/ML model predicts/outputs the LLRs and/or Symbols and/or Effective Channel Estimates.

The WTRU and/or NW may perform post-processing. Postprocessing may include one or more of extracting data and/or PRD REs, reshaping the AI/ML model output, and/or combining real and imaginary parts to obtain a complex-valued AI/ML model output. The WTRU and/or NW may extract data and/or PRD REs at the AI/ML model output.

The WTRU and/or NW may output data. AI/ML model output (e.g., data) may include one or more of LLR at data and/or PRD REs, LLRs at DMRS RE, symbols at data and/or PRD REs, symbols at DMRS REs, effective (e.g., precoded) channel estimates at each RE, effective noise variance, and/or Doppler estimate.

The WTRU and/or NW may perform training. The training may be performed online or offline in a supervised manner. The WTRU and/or NW may perform inference. For example, the WTRU may use the trained AI/ML-based joint receiver functions for demodulation. The WTRU and/or NW may perform performance monitoring. For example, the WTRU may be configured to perform data performance monitoring and/or perform OOD detection, for example during the inference. The WTRU may perform the data performance monitoring of AI/ML-based joint receiver functions by comparing data performance with respect to the non-AI/ML (e.g., legacy) receiver functions. The WTRU may perform the OOD detection test on the received REs, for example to identify whether the AI/ML model input data belongs to the same distribution as the distribution of the data used in the AI/ML model training.

The WTRU may perform capability exchange. The NW/gNB may initiate the WTRU capability exchange process, for example by sending a UECapabilityEnquiry RRC message to the WTRU. The message may be used to request specific information regarding the WTRU capabilities. The NW/gNB may include parameters in the message to specify which capabilities the NW is requesting. The NW/gNB may specify parameters related to WTRU capability in online learning of an AI/ML-based joint receiver functions for demodulation, for example in the UECapabilityEnquiry message.

The WTRU may respond with a UECapabilityInformation RRC message, for example after receiving the UE Capability Enquiry RRC message. The UECapabilityInformation RRC message may include (e.g., detailed) information about the WTRU capabilities. The WTRU and the NW may exchange information related to parameters related to the AI/ML functions, for example during the WTRU capability exchange process between the WTRU and the NW. The WTRU may use the receiver function training allocations and/or other training signals, for example depending on WTRU capabilities.

Capabilities signaling may include one or more of an indicator of whether type 1a receiver function training allocations is supported or not, an indicator of whether type 1b receiver function training allocations is supported or not, an indicator of whether type 2a receiver function training allocations is supported or not, an indicator of whether type 2b receiver function training allocations is supported or not, an indicator of whether generation of the high-quality labels via data allocations is supported or not, an indicator of whether type 3a receiver function training allocations is supported or not, an indicator of whether type 3b receiver unction training allocations is supported or not, and/or an indicator of whether generation of the high-quality labels via PRD allocations is supported or not.

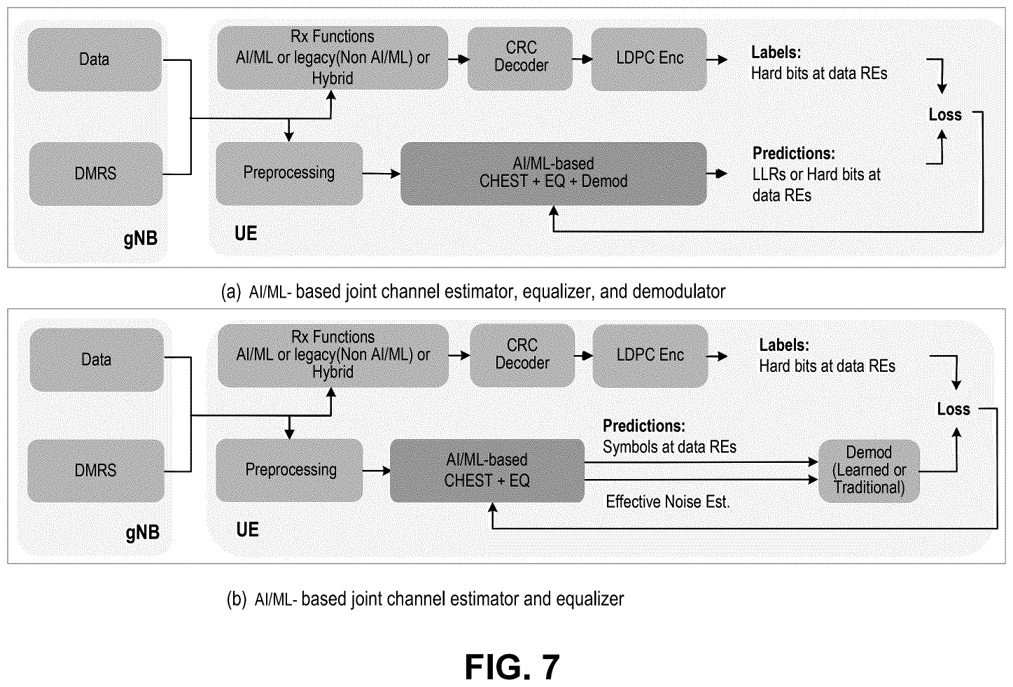

The WTRU may generate the hard bit labels at data REs by encoding or re-encoding the FEC (e.g., LDPC) outputs when CRC check succeeds (e.g., as in FIG. 7), for example for the indicator of whether generation of the high-quality labels via data allocations is supported or not. The WTRU may generate the symbol labels at data REs by re-encoding and/or re-modulating the FEC outputs when CRC check succeeds, for example for the indicator of whether generation of the high-quality labels via data allocations is supported or not. The WTRU may be signaled with the seed for PRD bit generator to generate the hard bits or symbols at data REs, for example for the indicator of whether generation of the high-quality labels via PRD allocations is supported or not. FEC may include one or more of LDPC, polar, and/or turbo.

The WTRU and/or NW may be configured. The NW may know the WTRU capability to support online learning of an AI/ML-based joint receiver functions for demodulation, for example through WTRU capability exchange process. The NW may configure the WTRU to perform online learning of an AI/ML-based joint receiver functions for demodulation (e.g., via RRC and/or MAC-CE signaling). The WTRU will receive the receiver function training allocations (e.g., via DCI and/or MAC-CE), for example as in a configuration.

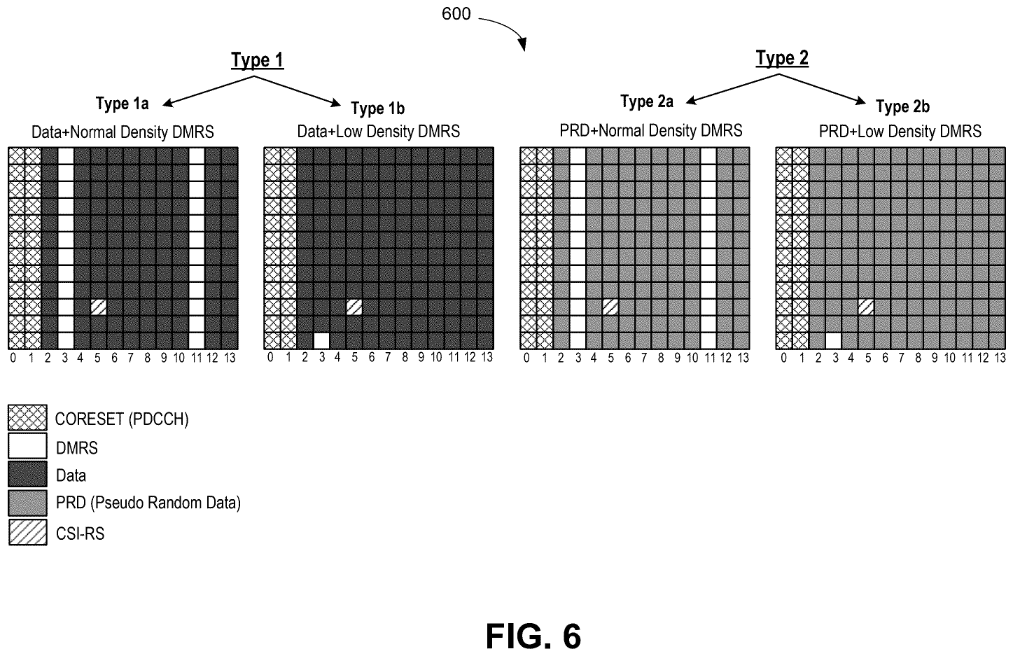

FIG. 6 illustrates the example receiver function training allocations 600. For example, the receiver function training allocations may include type 1, type 2, and/or type 3 receiver function training allocations. Type 1 receiver function training allocations may include data allocations. The allocated RBs and/or RBGs may carry data REs. The allocated RBs and/or RBGs may additionally, or alternatively, carry one or more of DMRS REs, CSI-RS REs, control channels (e.g., PDCCH), and/or other PHY channels. The WTRU may generate the high-quality labels (e.g., hard bits, symbols), for example via data allocations. The WTRU may generate the hard bit labels at data REs by re-encoding the LDPC outputs, for example when CRC check succeeds, for example as in FIG. 7. The WTRU may generate the symbol labels at data REs by re-encoding and/or re-modulating the LDPC outputs, for example when CRC check succeeds.

FIG. 7 shows type 1 examples of an AI/ML-based joint channel estimator, equalizer, and demodulator; and an AI/ML-based joint channel estimator and equalizer. The WTRU may use the AI/ML-based joint receiver functions and/or the non-AI/ML (e.g., legacy) receiver functions in generating the high-quality labels (e.g., as in FIG. 7). For example, the WTRU may use a combination of the AI/ML-based joint receiver functions and the non-AI/ML (e.g., legacy) receiver functions in generating the high-quality labels (e.g., hybrid receiver functions). The WTRU may use these high-quality labels to train AI/ML-based joint receiver functions.

Type 1 receiver function training allocations may be divided into two subcategories including type 1a and type 1 (e.g., as in FIG. 6). Type 1a receiver function training allocations may include the allocated RBs and/or RBGs which may carry normal density DMRS REs (e.g., 5G NR PDSCH DMRS configuration type 1 and/or configuration type 2). Type 1b receiver function training allocations may include the allocated RBs and/or RBGs which may carry low density DMRS REs (e.g., lower than 5G NR PDSCH DMRS configuration type 1 and/or configuration type 2). A lower number of DMRS REs may be (e.g., therefore) reserved compared to the DMRS patterns defined by 5G NR. Low density DMRS may result in more REs available for data transmission during one or more of the model training, performance monitoring, and/or inference, which for example may increase the spectral efficiency. The low density DMRS per layer may enable supporting higher number of layers via DMRS allocations.

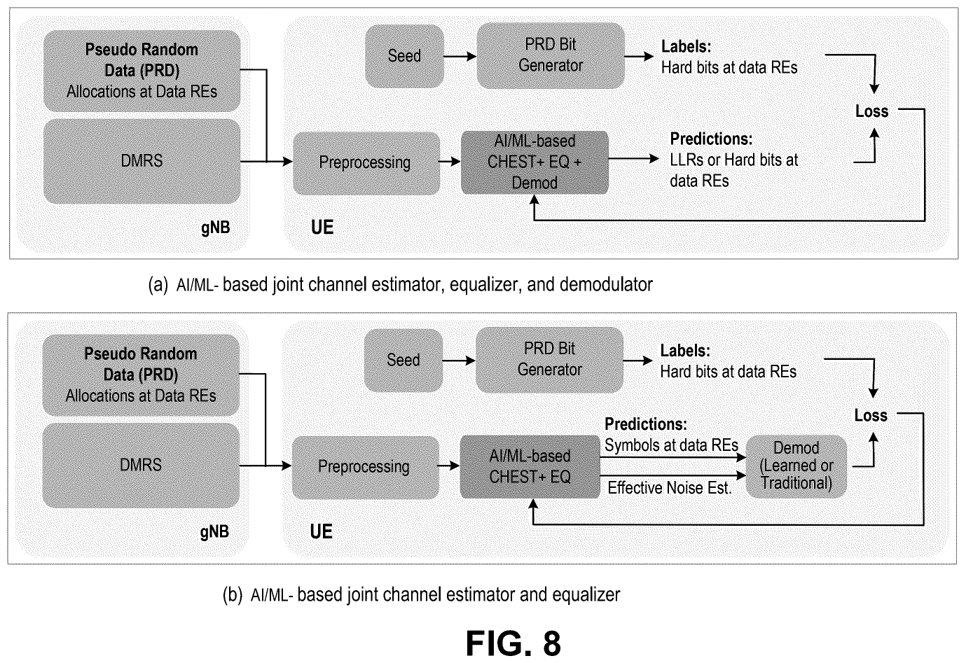

FIG. 8 shows type 2 examples of an AI/ML-based joint channel estimator, equalizer, and demodulator; and an AI/ML-based joint channel estimator and equalizer. Type 2 receiver function training allocations may include PRD allocations. For example, type 2 receiver function training allocations may include the allocated RBs and/or RBGs which may carry PRD REs. Additionally, or alternatively, the type 2 receiver function allocations may include the allocated RBs and/or RBGs which may carry one or more of DMRS REs, CSI-RS REs, control channels (e.g., PDCCH), and/or other PHY channels. The WTRU may generate the high-quality labels (e.g., hard bits, symbols) via PRD allocations. For example, the WTRU may generate the hard bit labels at data REs via PRD bit generator and/or the corresponding signaled seed (e.g., as in FIG. 8).

The WTRU may use the high-quality labels to train AI/ML-based joint receiver functions. Type 2 receiver function training allocations may be divided into two subcategories including type 2a and type 2b, for example as shown in FIG. 6. Type 2a receiver function training allocations may include the allocated RBs and/or RBGs which may carry normal density DMRS REs (e.g., 5G NR PDSCH DMRS configuration type 1 and/or configuration type 2).

Type 2b receiver function training allocations may include the allocated RBs and/or RBGs which may carry low density DMRS REs (e.g., lower than 5G NR PDSCH DMRS configuration type 1 and/or configuration type 2). A lower number of DMRS REs may (e.g., therefore) be reserved compared to the DMRS patterns defined by 5G NR. Type 2 receiver function training allocations may include the low density DMRS, which for example may result in the allocating more PRD REs during the model training and performance monitoring. Type 2 receiver function training allocations may include the low density DMRS, which for example may result in more REs available for data transmission during the inference (e.g., which may increase the spectral efficiency). Type 2 receiver function training allocations may include the low density DMRS per layer, which for example may enable supporting higher number of layers via DMRS allocations.

Type 3 receiver function training allocations may include (e.g., both) data (e.g., allocations) and PRD allocations. Allocated RBs and/or RBGs may jointly carry both data REs and PRD REs. The allocated RBs and/or RBGs may additionally, or alternatively, carry one or more of DMRS REs, CSI-REs, and/or control channels (e.g., one or more of PDCCH and/or other physical channels). The WTRU may generate the high-quality labels (e.g., hard bits and/or symbols) using both data allocations and PRD allocations. The WTRU may generate the labels (e.g., hard bits) at PRD allocated REs by using the PRD generator at PRD allocated REs. The WTRU may (e.g., then) re-encode the FEC decoder output at data allocated REs, for example when the CRC check succeeds (e.g., does not have an error). The WTRU may use the high-quality labels to train AI/ML-based joint receiver functions.

Type 3 receiver function training allocations may be divided into type 3a receiver function training allocations and type 3b receiver function training allocations. The allocated RBs and/or RBGs may carry normal density REs (e.g., 5G NR PDSCH DMRS configuration type 1 and/or type 2), for example for type 3a receiver function training allocations.

The allocated RBs and/or RBGs may carry low density REs (e.g., lower than 5G NR PDSCH DMRS configuration type 1 and/or type 2), for example for type 3b receiver function training allocations. A lower number of DMRS REs may be reserved compared to DMRS patterns in 5G NR, for example for type 3b. Low density DMRS may result in allocating more data REs and/or PRD REs, for example during model training and/or performance monitoring. Additionally, or alternatively, low density DMRS may result in more REs (e.g., data REs and/or PRD REs) available for data transmission, for example during transmission. More REs (e.g., data REs and/or PRD REs) available for data transmission may increase spectral efficiency. Low density DMRS per layer may enable support for a higher number of layers via DMRS allocations.

A WTRU may be configured by the NW via higher layer signaling (e.g., RRC signaling) SIB, for example to perform online learning of an AI/ML-based joint receiver functions for demodulation. The configuration may include one or more of an indication that type 1 receiver function training is supported or not by the NW, a type 1 receiver function training allocation scheduling, an indication that type 2 receiver function training is supported or not by the NW, an indication that type 3 receiver function training is supported or not by the NW, resource mapping, a grouping of WTRU in PRD group(s), a size of receiver function training allocations, a set of usable RBs and/or RBGs, and/or AI/ML model training parameters. Resource mapping may include one or more of antenna ports, receiver function training allocation patterns, and/or etc. The grouping of WTRUs in PRD group(s) may be for (e.g., different) receiver function training allocations opportunities. The AI/ML model training parameters may include one or more of a loss function, training performance metric and threshold, and/or etc.

The WTRU may be configured with the type 1 receiver function training allocation scheduling for example if type 1 receiver function training is supported by the NW and/or if the configuration includes the indication that type 1 receiver function training is supported by the NW. The type 1 receiver function training allocations scheduling may be multiplexed, for example (e.g., concurrently) with one or more of data, normal or low density DMRS REs, and/or other RS (e.g., normal CSI-RS, etc.). Type 1 receiver function training allocations may be WTRU specific allocations, for example as the allocated RBs and/or RBGs may carry the WTRU specific data. Type 1 receiver function training allocations may be dynamic (e.g., signaled in one or more of RRC, DCI, MAC-CE, and/or similar control channels) or semi-static, for example with training allocation information indicated in SIB and/or other broadcast messages.

The WTRU may be configured with the type 2 receiver function training allocation scheduling for example if type 2 receiver function training is supported by the NW and/or if the configuration includes the indication that type 2 receiver function training is supported by the NW. The type 2 receiver function training allocations may be non-specific to any WTRU and/or non-specific to any WTRU within PRD group(s) indicated for the training allocation. Multiple WTRUs may simultaneously use the same allocations. The non-specific semi-static allocations may be broadcast, for example such that any WTRU with capabilities to read SIB may read the receiver function training allocations. Type 2 receiver function training allocations may be dynamic (e.g., signaled in one or more of RRC, DCI, MAC-CE, and/or similar control channels), or semi-static with training allocation information indicated in SIB or other broadcast messages.

The WTRU may be configured with the type 3 receiver function training allocation scheduling for example if type 3 receiver function training is supported by the NW and/or if the configuration includes the indication that type 3 receiver function training is supported by the NW. The type 3 receiver function training allocations may be multiplexed (e.g., concurrently) with one or more of data, PRDs, normal or low density DMRS REs, and/or other RS (e.g., normal CSI-RS, etc.). The type 3 receiver function training allocations may include both WTRU specific allocations similar to type 1 receiver function training allocations (e.g., allocated RBs and/or RGBs carry WTRU specific data) and non-specific WTRU allocations similar to type 2 receiver function training allocations (e.g., multiple WTRUs may simultaneously use the same allocations).

The WTRU and/or the NW may perform signaling of online training. The WTRU may transmit an online training request. The WTRU and/or NW may determine and/or detect a need for initiating online learning of AI/ML-based joint receiver functions. The WTRU may initiate the online training, for example via signaling of an online training request and/or an online training response.

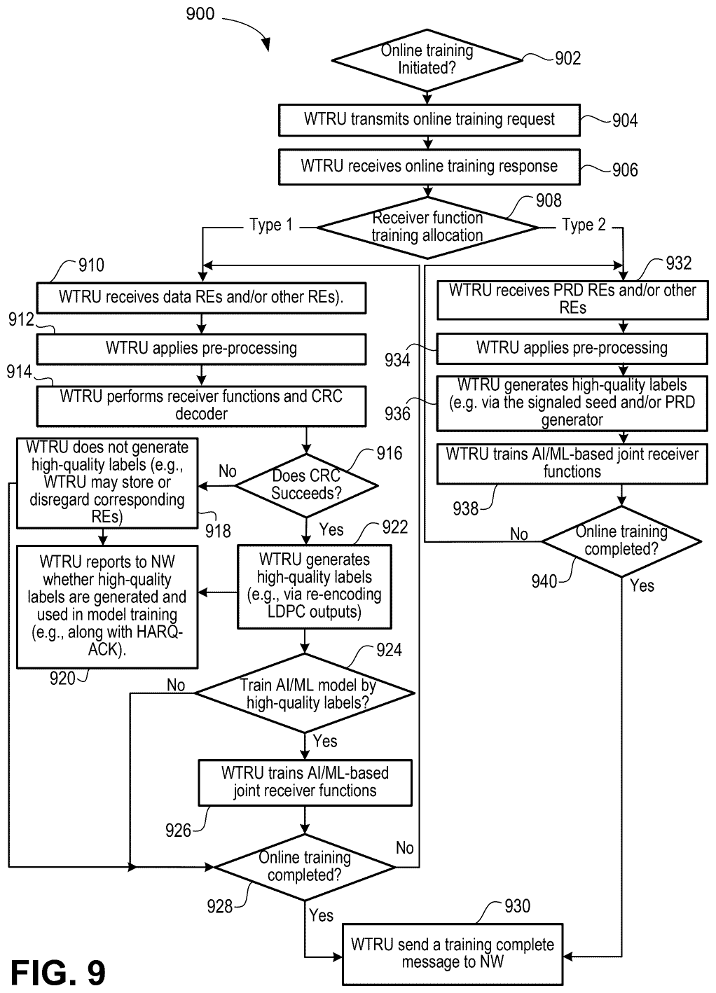

FIG. 9 is an example of AI/ML model training 900. At 902 the WTRU and/or the network may initiate online training. At 904 the WTRU may transmit an online training request, for example to the NW. The WTRU may transmit the online training request via one or more of PUCCH, MAC-CE, RRC, and/or NAS message. The online training request may include an indication of one or more of a training BW and/or number of RBs, channel statistics measurement(s), a number of layers, maximum number of layers, list of number of layers desired for training, desired sequence of DMRS configurations, a method for selecting precoders, which receiver functions are to be performed by AI/ML-based joint receiver functions, training performance metric(s), priority request(s), training data diversity request(s), variable code rate request(s), and/or one or more WTRU capabilities.

The NW may use the request to decide the size of the receiver function allocations, for example for training BW and/or number of RBs. Channel statistics measurement(s) may include one or more of delay spread, Doppler, K-factor of LOS components, and/or power delay profile (PDP). A methods for selecting precoders may include one or more of round robin, a list of precoder table indices, and/or be based on a (e.g., latest) CSI report. The indication of which receiver functions are performed by AI/ML-based joint receiver functions may include one or more of (e.g., a combination of) any channel estimator, equalizer, and/or demodulator.

The WTRU may receive a performance threshold from the NW, for example for the training performance metric(s). The threshold and/or the training performance metric may include one or more of a target model loss (e.g., binary cross entropy) and/or data performance metric (e.g., BER, BLER, and/or throughput). The threshold and/or the training performance metric may be via DCI and/or MAC-CE. The threshold and/or the training performance metric may be for the WTRU to detect whether the training is sufficient and/or WTRU monitoring and/or reporting of the AI/ML model performance.

The online training request may include the indication of the priority request. The WTRU may indicate a high priority, for example if the performance of the AI/ML-based joint receiver functions is below a certain threshold. The WTRU may receive the performance threshold from the NW. The performance threshold may include one or more of a target model loss (e.g., binary cross entropy) and/or data performance metric (e.g., BER, BLER, and/or throughput), for example via DCI or MAC-CE. The threshold and/or the training performance metric may be for the WTRU to detect whether the training is sufficient and/or WTRU monitoring and/or reporting of the AI/ML model performance. The WTRU may indicate a low priority, for example if the request is for predictive maintenance (e.g., the quality of an AI/ML-based joint receiver functions may be tested via the high-quality labels generated). If the comparison indicates the AI/ML model performance has degraded compared to a threshold for example, the WTRU may signal the NW with a new message to increase the priority of receiver function training allocation.

The online training request may include the indication of training data diversity request. The WTRU may request increased diversity of training data, for example one or more of different modulation order that are deficient in training data and/or a different code rate to increase the possibility of CRC success).

The online training request may include the indication of variable code rate request. For example when the WTRU is configured with type 1 and/or type 3 receiver function training allocations, the WTRU may request variable code rate configuration during the model training. AI/ML-based joint receiver functions performance may improve during the model training, which for example may increase the probability of CRC success while generating high-quality labels. The WTRU may (e.g., then) request an increased code rate through UCI and/or MAC-CE, for example for opportunistically increasing the spectral efficiency while successfully generating labels.

The online training request may include the indication of WTRU capability. The WTRU may report one or more of the WTRU capabilities (e.g., capability of generating labels via re-encoding with FEC, compute capability) and/or dynamic conditions (e.g., WTRU power saving state), for example so that the WTRU can be configured with type 1, type 2, and/or type 3 receiver function training allocations (e.g., via DCI and/or MAC-CE).

At 906 the WTRU may receive an online training response. The NW may transmit the online training response to the WTRU as the response to the online training request. The online training response may indicate one or more of the location of RBs and/or RBGs of the receiver function training allocations, the type of receiver function training allocations (e.g., type 1a, type 1b, type 2a, type 2, type 3a, and/or type 3b, etc.), the seed for PRD generator for type 2 and/or type 3 receiver function training allocations, an allocated online training duration (e.g., number of slots) and the starting time, an allocated online training pattern, an antenna port structure, a density, a power offset, an indication of WTRU specific and/or WTRU non-specific receiver function training allocation(s) (e.g., when AI/ML-based joint receiver functions exclude the demodulator, the NW may share the corresponding constellation with the WTRU via DCI or MAC-CE), an indication of whether the NW modulates data symbols via an arbitrary constellation or not, and/or an indication of training performance metric(s).

The indication of the training performance metric(s) may be provided by a network. The network may configure a WTRU with a performance threshold (e.g., a target model loss and/or data performance metric via DCI and/or MAC-CE), for example so that WTRU may detect whether the training is sufficient and/or the WTRU may monitor and/or report the AI/ML model performance.

The WTRU may receive a configuration to perform online training, for example in the online training response. Alternatively, the WTRU may receive the configuration to perform online training in a separate message. The WTRU may receive the receiver function training allocation to perform online training at 908, for example in the configuration. The receiver function training allocation may include an indication of type 1, type 2, and/or type 3.

The WTRU may generate high-quality labels via received data allocations, for example for type 1 receive functions training allocations. At 910 the WTRU may receive data REs and/or other REs. At 912 the WTRU may preprocess (e.g., the data REs and/or other REs). At 914 the WTRU may perform receiver function(s) and/or CRC decoder. At 916 the WTRU may perform a CRC check and/or determine if the CRC check is successful (e.g., there are no errors).

At 918 the WTRU may not generate labels, for example if the CRC check of the FEC output fails. The WTRU may (e.g., then) store and/or disregards the corresponding received REs. At 920 the WTRU may send a message, for example to the network, indicating whether the high-quality labels are generated and/or used in model training. The message may be sent with HARQ feedback (e.g., ACK). If the high-quality labels are not generated for example, the WTRU may report that the labels are not generated. The WTRU may (e.g., after 918) determine if (e.g., online) training is complete (e.g., at 928). If training is complete for example, the WTRU may send a training complete message at 930 (e.g., to the network). If training is not complete for example, the WTRU may determine to return to train an AI/ML model (e.g., at 924).

At 922 the WTRU may generate the high-quality labels (e.g., hard bits), for example via the receiver functions (e.g., AI/ML or legacy (e.g., non-AI/ML) or hybrid). The WTRU may generate the high-quality labels for example if the CRC check succeeds. Additionally, or alternatively, the WTRU may perform CRC decoder and/or re-encoding of the FEC (e.g., low density parity check (LDPC)) output, for example if the CRC check succeeds. At 920 the WTRU may report (e.g., to the network) whether the high-quality labels are generated and/or used in model training. The report may additionally, or alternatively, include HARQ feedback (e.g., ACK). If the high-quality labels are generated for example, the WTRU may report that the labels are generated.

At 924 the WTRU may train an AI/ML model, for example using the high-quality labels. At 926 the WTRU may (e.g., then) train AI/ML-based joint receiver functions, for example using the labels. At 928 the WTRU may determine if (e.g., online) training is complete. If training is complete for example, the WTRU may send a training complete message at 930 (e.g., to the network). If training is not complete for example, the WTRU may determine to return to train an AI/ML model (e.g., at 924).

The receiver function training allocation, for example at 908, may include an indication of type 2. At 932 the WTRU may receive PRD REs and/or other REs. At 934 the WTRU may preprocess (e.g., the PRD REs and/or other REs). At 936 the WTRU may generate the high-quality labels (e.g., hard bits and/or symbols), for example via PRD generator and/or a PRD seed. The PRD seed may be sent (e.g., to the WTRU) by the network, for example with the receiver function training allocation. At 938 the WTRU may train AI/ML-based joint receiver functions, for example using the labels. At 940 the WTRU may determine if (e.g., online) training is complete. If training is complete for example, the WTRU may send a training complete message at 930 (e.g., to the network). If training is not complete for example, the WTRU may determine to return to receive PRD REs and/or other REs (e.g., at 932). The WTRU may send a message (e.g., to the network) to indicate training is not complete and/or to request PRD REs and/or other REs. The WTRU may generate the high-quality labels using both the received data and PRD allocations, for example, for type 3 receiver function training allocations. The labels may be generated using the received data associated with (e.g., scheduled by) the data allocations and the received PRD associated with (e.g., scheduled by) the PRD allocations, for example for the third receiver function training allocation type (e.g., type 3).

The WTRU may transmit feedback (e.g., the message) associated with the training allocations, for example via one or more of UCI and/or MAC-CE. For example, the WTRU may send one or more CSI reports (e.g., to the network). The WTRU may include a (e.g., first) CSI report associated with transmission of the receiver function allocations with data REs and/or PRD REs, for example to be (e.g., simultaneously) used for model training. The WTRU may include a (e.g., second) CSI report, for example for transmission and/or not used for training. The WTRU may include (e.g., another) a CSI report with the combinations of the transmissions used for the training and not used for the training. The WTRU may indicate/report whether the high-quality labels generated by using type 1 receiver functions training allocations were utilized in the model training or not (e.g., when the high-quality labels are not utilized in the AI/ML model training, the WTRU may report along with HARQ-ACK).

The WTRU may train an AI/ML model. The WTRU may be configured by the NW, for example using higher signaling (e.g., RRC, SIB, and/or MAC-CE, etc.), for online training of an AI/ML-based joint receiver functions. The WTRU may train the AI/ML model using type 1 and/or type 2 receiver function training allocations as in FIG. 9 for example. The WTRU may train the AI/ML model using type 3 receiver function training allocations (e.g., both data and PRD allocations) may use procedures for both type 1 and type 2 receiver function training allocations (e.g., as in FIG. 9). The WTRU may determine/calculate model loss, for example by comparing the model predictions and high-quality labels (e.g., while training AI/ML-based joint receiver functions).

The WTRU may share training data, for example the training dataset. The WTRU may save the dataset (e.g., one or more of received DMRS REs, data REs, PRD RES, CSI-RS REs, DMRS pilots CSI-RS pilots, RSRP, LS estimate of effective (precoded) channel, noise power estimate, and/or high-quality labels), for example in a replay buffer. The WTRU may use the replay buffer for one or more of continued model training and/or for (e.g., model) performance monitoring. The WTRU and/or NW may use the replay buffer, for example to create augmented training datasets. The WTRU share/transmit the saved dataset to the NW. For example, the WTRU may be configured to share the saved dataset with the NW through RRC and/or MAC-CE signaling.

The WTRU may report a training status. The WTRU may be configured with a target model loss (e.g., binary cross entropy) and/or data performance metric (e.g., BER, BLER, and/or throughput), for example through DCI, RRC, and/or MAC-CE signaling. The WTRU may detect whether the training is sufficient, for example based on the configuration. The WTRU may send a training status message (e.g., to a gNB via UCI and/or MAC-CE), for example if the WTRU detects the training is sufficient by using the configured target model loss and/or data performance metric.

The WTRU may train a model and/or generate labels. The WTRU and/or NW may be triggered (e.g., detect a need) to initiate online learning of AI/ML-based joint receiver functions. The WTRU may request online training of AI/ML-based joint receiver functions. The WTRU may include a (e.g., first) CSI (e.g., report) associated with transmission of data and/or PRD, for example to be (e.g., simultaneously) used for model training. The WTRU may include a (e.g., second) CSI (e.g., report), for example for transmission not used for training. A request may be send with and/or in a CSI report. The request may additionally, or alternatively, be made in in an independent transmission, for example that includes a CSI report (e.g., through UCI and/or MAC-CE).

The WTRU may request increased diversity of training data (e.g., different modulation order that are deficient in training data, a different code rate to increase the possibility of CRC success). The WTRU may report WTRU capabilities (e.g., capability of generating labels via re-encoding with FEC, compute capability) and/or dynamic conditions (e.g., WTRU power saving state), for example so that the WTRU may be configured with (e.g., either) type 1, type 2, and/or type 3 receiver function training allocations (e.g., via DCI and/or MAC-CE). The WTRU may be configured with a target model loss (e.g., binary cross entropy) and/or data performance metric (e.g., BER, BLER, and/or throughput) (e.g., via DCI and/or MAC-CE), for example so that WTRU may detect whether the training is sufficient. The WTRU may receive a corresponding constellation (e.g., through DCI and/or MAC-CE), for example if AI/ML-based joint receiver functions exclude the demodulator and/or the NW modulates the data symbols via an arbitrary constellation (e.g., non-square QAM).

The WTRU may be configured with (e.g., either) type 1, type 2, and/or type 3 receiver function training allocations (e.g., through DCI and/or MAC-CE). The WTRU generates high-quality labels by using data allocations, for example if the WTRU is configured with type 1 receiver function training allocations. The WTRU may generate labels, for example hard bits, by re-encoding the FEC decoder output (e.g. if the CRC check succeeds). If the CRC check of the FED decoder output fails for example, the WTRU may not generate labels. The WTRU may (e.g., either) store and/or disregard the corresponding received REs. The WTRU may generate high-quality labels by using PRD allocations, for example if the WTRU is configured with type 2 receiver function training allocations.

The WTRU may generate labels including one or more of bits (e.g., hard bits) and/or symbols, for example when the WTRU is configured with type 3 receiver function training allocations. The labels may be hard bits, for example generated using PRD generator. The WTRU may be signaled with the seed of PRD generator, for example by the NW. Type 1, type 2, and/or type 3 receiver function training allocations may have either low or normal density DMRS allocations.

The WTRU may be configured with type 1 receiver function training allocations. The WTRU may generate the high-quality labels by using one or more of legacy (e.g., non-AI/ML) receiver functions and/or AI/ML-based joint receiver functions. The WTRU may indicate/report whether the corresponding labels were utilized in the model training (e.g., along with HARQ-ACK), for example through UCI and/or MAC-CE.

The WTRU may request a variable code rate configuration (e.g., during the model training), for example if the WTRU generates the high-quality labels by using AI/ML-based joint receiver functions. The performance of AI/ML-based joint receiver functions may improve during the model training, which may increase the probability of CRC success while generating high-quality labels. The WTRU may request an increased code rate (e.g., through UCI and/or MAC-CE), for example for opportunistically increasing the spectral efficiency while successfully generating labels. The WTRU may be assigned to a PRD group to receive the non-specific receiver training function allocations, for example if the WTRU is configured with type 2 receiver function training allocations.

The WTRU may train the AI/ML-based joint receiver functions. The WTRU may calculate/determine model loss, for example by comparing the model predictions and high-quality labels. Model input may include one or more of received DMRS REs, data REs, PRD REs, CSI-RS REs, DMRS pilots CSI-RS pilots, RSRP, LS estimate of effective (precoded) channel, and/or noise power estimate. Model output may include one or more of symbols at data REs, DMRS REs, and/or effective noise estimates, for example for AI/ML-based joint channel estimator and equalizer. Additionally, or alternatively, model output may include one or more of log-likelihood ratio (LLR), hard bits at data REs, and/or DMRS REs, for example for one or more of AI/ML-based joint channel estimator, equalizer, and demodulator and/or AI/ML-based joint channel estimator and demodulator.

The WTRU may transmit feedback, for example associated with training allocations. The feedback may be transmitted through one or more of UCI and/or MAC-CE for example. The WTRU may include a (e.g., first) CSI associated with transmission of data and/or PRD, (e.g., to be simultaneously used for model training during AI/ML model training) for example in the transmission. The WTRU may include a (e.g., second) CSI for transmission not used for training, for example in the transmission.

The WTRU may save the dataset (e.g., one or more of received DMRS RES, data REs, PRD REs, CSI-RS REs, DMRS pilots CSI-RS pilots, RSRP, LS estimate of effective (precoded) channel, noise power estimate, and/or high-quality labels), for example in a replay buffer. The WTRU may use the replay buffer for a continued model training and/or for the performance monitoring. The WTRU and/or NW may use the replay buffer to create augmented training datasets, for example by permutating (e.g., various) aspects of the datasets. For example, the WTRU and/or NW may create augmented training data sets by adding noise and/or other channel impairment effects. The WTRU may share a saved dataset with the NW (e.g., WTRU may be configured to share the saved dataset with the NW). The WTRU may send a training status message to gNB (e.g., via UCI and/or MAC-CE), for example when WTRU detects the training is sufficient.

The WTRU and/or network may use numerical results, for example to evaluate performance of the proposed online learning of the joint receiver functions for demodulation. AI/ML-based joint receiver functions may include one or more of the channel estimator, equalizer, and demodulator. The WTRU may perform a simulation, for example with an open-source Python library for the link-level simulations based on TensorFlow (e.g., Sionna).

Example simulation parameters are summarized in Table 1. The WTRU may be configured with 10 MHz bandwidth, for example with numerology μ=2 (e.g., 60 kHz subcarrier spacing, 11 RBs with 132 subcarriers).

TABLE 1
Example simulation parameters

| Scenario | Downlink | |
|---|---|---|
| Number of Tx Antenna at gNB | 1 | |
| Number of Tx Antenna at WTRU | 1 | |
| Channel Model | Clustered delay line (CDL)-B | |
| Delay Spread | 300 | ns |
| Channel Normalization | True (Enabled) | |
| Subcarrier Spacing | 60 | KHz |
| Number of RBs | 11 | |
| Bandwidth | 10 | MHz |

| | |
|---|---|
| Modulation | 64-QAM |
| Coderate | 0.5 |
| DMRS Configuration | Normal Density (Configuration |
| | type 1) or Low Density |
| WTRU Velocity | 10 km/h or 60 km/h or 120 km/h |
| SNR | [10 dB, 20 dB] |

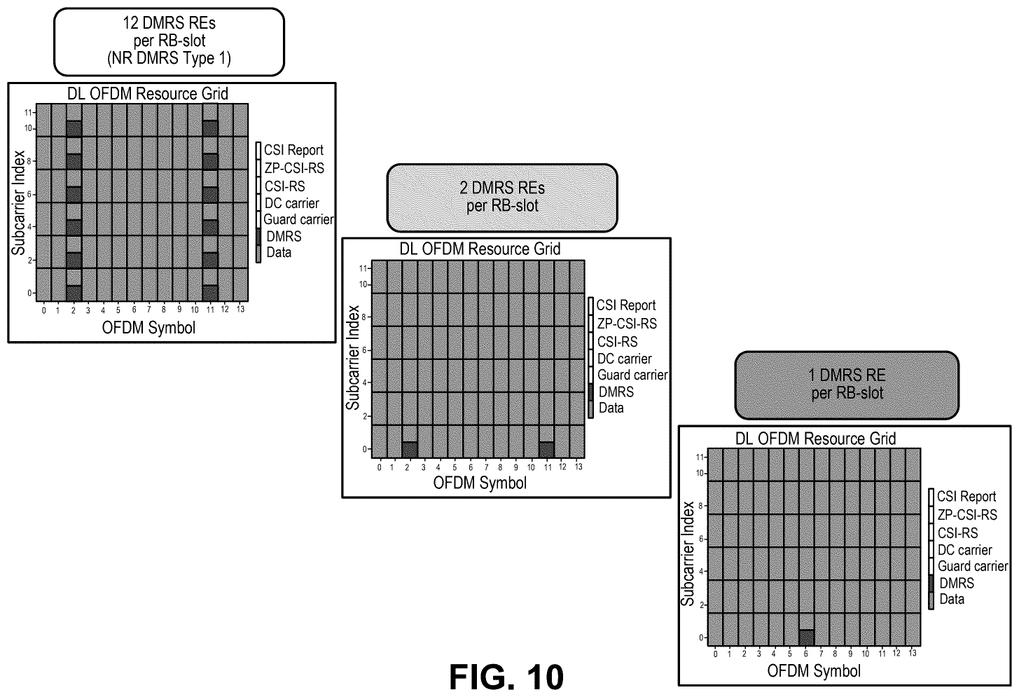

FIG. 10 shows example DMRS densities. The DMRS densities may be considered during performance evaluations. A normal DMRS density may include 12 DMRS RE per RB-slot (e.g., as in 5G NR). A low DMRS density may include 2 DMRS RE per RB-slot. A low DMRS density may include 1 DMRS RE per RB-slot. The WTRU and/or NW may multiplex DMRS REs with the data Res, for example across the OFDM resource grid. The WTRU may be configured with type 1 receiver function training allocation (e.g., the data REs may be allocated to train the AI/ML-based joint receiver functions). The OFDM resource grid may include 14 OFDM Symbols×132 Subcarriers=1848 REs, for example where the normal DMRS density scenario (e.g., 12 DMRS RE per RB-slot) may allocate 132 DMRS REs and/or 1716 data REs. A low DMRS density scenario (e.g., 1 DMRS RE per RB-slot) may allocate 11 DMRS REs and/or 1837 data REs. Low DMRS density allocations may enable increasing the number of data RE allocations, for example by 7.05%.

Example AI/ML model training parameters are given in Table 2. The batch size may be 4096 slots per run. The AI/ML model may be trained for 2000 runs. The model may be (e.g., therefore) trained for 8,192,000 slots.

TABLE 2
Example AI/ML model training parameters

| | |
|---|---|
| Batch Size | 4096 Slots |
| Number of Runs | 2000 for Training \| 1 for Test |
| Training Dataset Size | $8 , 192 , 000 Slots = 4096 \frac{Slots}{Run} \times$ |
| | 2000 Runs |
| Training Dataset | 90% Training \| 10% Validation |
| Split | |
| Optimizer | Adam |
| Learning Rate | 0.001 |
| Model Params | 4.97M |

Example OFDM resource grids are also shown in FIG. 10. The OFDM resource grid may have normal DMRS density (e.g., 12 DMRS REs per RB-slot) and low DMRS density (e.g., 2 or 1 DMRS RE per RB-slot). The AI/ML-based joint receiver function for the joint channel estimator, equalizer, and demodulator may be (e.g., built) as in FIG. 5 for example. For example, the AI/ML model may be constructed with one or more of concatenation, convolution, layer normalization, ReLU activation layers, and/or residual connections. The inputs of AI/ML model may include (e.g., all) received REs (e.g., received data REs and received DMRS REs). The outputs of AI/ML model may include (e.g., only) the LLRs at data REs.

The WTRU and/or NW may perform an AI/ML process. The WTRU may input data. Input data may include (e.g., all) received REs, for example received data REs and received DMRS REs. An example input data shape may be 14×132 (e.g., 14 OFDM symbols and/or 132 subcarriers).

The WTRU may perform pre-processing. The WTRU may perform pre-processing by extracting the received data REs and/or DMRS REs, for example from the received signals using the configured allocations. Additionally, or alternatively, pre-processing may include concatenation of real and/or imaginary parts, for example to obtain a real-valued AI/ML model input. An AI/ML Model may be (e.g., built) (e.g., as in FIG. 5), for example where convolutional layers in residual blocks may have 128 filters with a 3×3 kernel size. The total number of trainable parameters may be 4.97M.

A WTRU may perform post-processing. The WTRU may perform post-processing by extracting (e.g., only) data REs at the AI/ML model output and/or reshaping the AI/ML model output. The AI/ML model may output data. The output data may include LLRs, for example for data bits at data REs. An example output data shape with 64-QAM modulation (e.g., as in Table 1) may include 1716×6 for normal DMRS density with 12 DMRS RE per RB-slot, 1826×6 for low DMRS density with 2 DMRS RE per RB-slot, and/or 1837×6 for low DMRS density with 1 DMRS RE per RB-slot.

The WTRU may train the AI/ML model, for example online. The WTRU may perform online training by using the high-quality hard bit labels, for example generated through type 1 receiver function training allocations (e.g., as in FIG. 6). The WTRU may perform an inference (e.g., test). For example, the WTRU may perform the inference (e.g., test) using the trained AI/ML-based joint receiver functions for demodulation. The WTRU may use one or more of throughput and/or BLER metrics for performance evaluations.

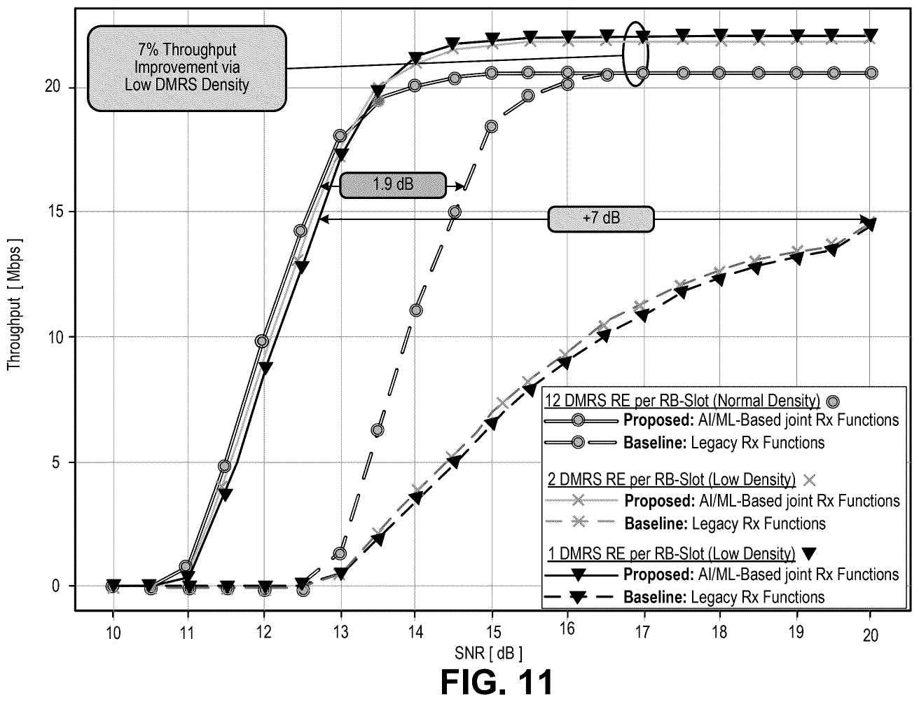

FIG. 11 is an example plot of throughput performance versus SNR. An example WTRU velocity may be 10 km/h. Performance of the AI/ML-based joint receiver functions disclosed herein is compared with legacy (e.g., non-AI/ML) receiver functions. Legacy receiver functions may include one or more of the LS channel estimator and linear interpolator, and/or linear minimum mean square error (LMMSE) equalizer and conventional QAM demodulator.

The AI/ML-based joint receiver functions may achieve 1.9 dB improvement in SNR in comparison to the legacy receiver functions, for example when the normal DMRS density is used. Additionally, or alternatively, the performance gap may (e.g., further) increase, for example when the WTRU is configured with low DMRS density (e.g., approximately 7 dB improvement in SNR at 15 Mbps throughput). When the DMRS density is reduced, a (e.g., large) performance degradation may occur in the legacy receiver functions, while for example the AI/ML-based joint receiver functions as herein may experience only 0.15 dB performance degradation in SNR for SNR<13 dB. The AI/ML-based joint receiver functions disclosed herein may enhance the throughput by 7%, for example by allocating more data REs with low DMRS density.

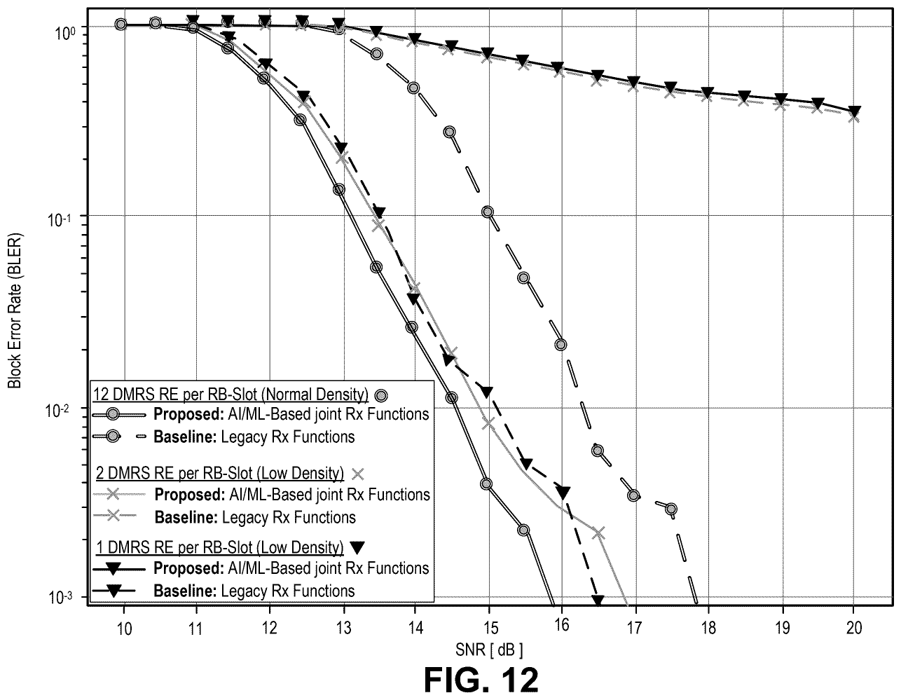

FIG. 12 shows example BLER performance versus SNR. The WTRU velocity may be 10 km/h. The AI/ML-based joint receiver functions disclosed herein may achieve the same slope in BLER curves for low and/or normal DMRS density scenarios, for example unlike legacy receiver functions.

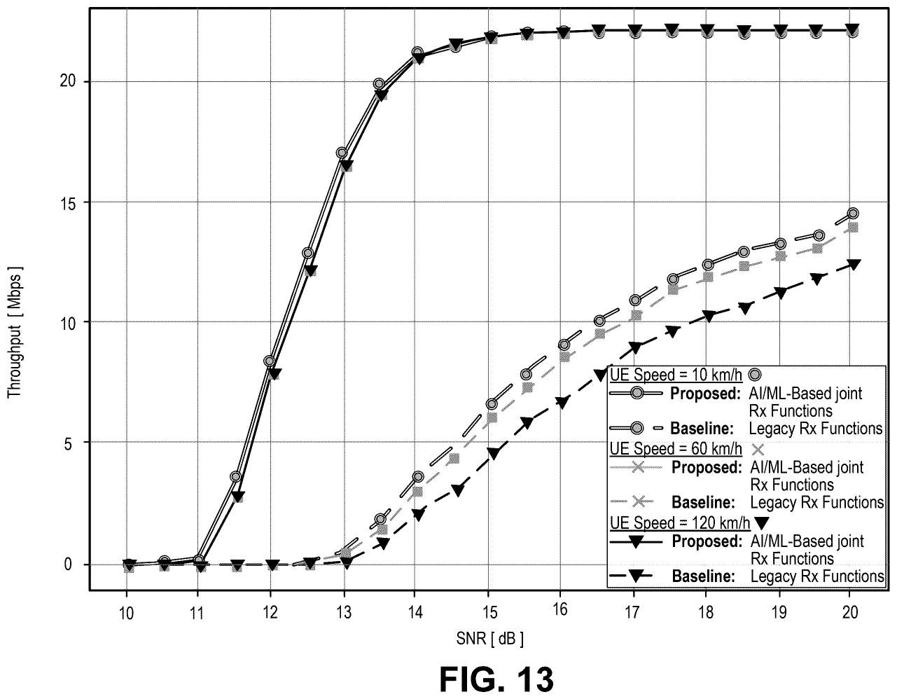

FIG. 13 shows example throughput performance versus SNR. The WTRU may be configured with low DMRS density (e.g., 1 DMRS RE per RB-slot). Additionally, or alternatively, the WTRU velocity may be set to 10 km/h, 60 km/h, or 120 km/h for example. The AI/ML-based joint receiver functions disclosed herein may be robust to both lower DMRS density and/or increased WTRU velocity, for example as shown in the numerical results.

Systems and methods for AI/ML model performance monitoring of joint receiver functions are disclosed herein. A WTRU and/or NW may deploy AI/ML-based joint receiver functions for online inference. The WTRU and/or NW may (e.g., then) monitor AI/ML model performance. The performance monitoring may enable a WTRU to one or more of continue using the existing model, fallback to the legacy (e.g., non-AI/ML) techniques for the receiver functions, and/or retrain/fine-tune the current model (e.g., after performance degradation).

Systems and methods disclosed herein may be for performance monitoring of AI/ML-based joint receiver functions. A WTRU may be configured to perform performance monitoring of an AI/ML-based joint receiver functions, for example for demodulation via one or more of RRC and/or MAC-CE signaling. The WTRU may receive the receiver function performance monitoring allocations (e.g., through DCI and/or MAC-CE), for example in the configuration. The receiver function performance monitoring allocations may include one or more of type 1, type 2, and/or type 3 receiver function performance monitoring allocations, for example as in FIG. 6.

The WTRU may be configured to apply OOD detection, for example for the inputs/outputs of the AI/ML-based joint receiver functions for demodulation. Parameters (e.g., key parameters) may be configured by the NW (e.g., via higher layer signaling, RRC signaling, and/or SIB), for example when the WTRU is configured to apply OOD detection. The configuration may include an indication of one or more of a reference distribution of the inputs and/or outputs of the AI/ML models used in offline training, an OOD algorithm, an OOD result type (e.g., binary or non-binary), an OOD test threshold, a period, and/or a minimum number of stored consecutive OOD events. The period may be denoted by T_{OOD}, and/or may be to store OOD events. The minimum number of stored consecutive OOD events, N, may be stored within the configured period T_{OOD}, for example to trigger one or more of reporting the OOD events to the NW, falling back to the legacy/non-AI/ML receiver functions, and/or requesting updating/retraining the AI/ML model.

The WTRU may be configured to perform data performance monitoring, for example of AI/ML-based joint receiver functions. Parameters (e.g., key parameters) may be configured by the NW (e.g., via higher layer signaling, RRC signaling, and/or SIB), for example when the WTRU is configured to perform data performance monitoring, for example of AI/ML-based joint receiver functions. The configuration may include one or more of a target data performance metric (e.g., BER, BLER, and/or throughput), a target threshold, and or a period. The period may be denoted by T_{monitoring}, and/or may be to store performance monitoring results.

A WTRU may be configured to use an AI/ML model for the joint receiver functions, which for example may be trained (e.g., either) online and/or offline. The WTRU may be configured and/or triggered to apply the data performance monitoring of AI/ML-based joint receiver functions (e.g., comparing its data performance with respect to the conventional legacy (e.g., non-AI/ML) receiver functions). The WTRU may be triggered to apply the data performance monitoring by an out-of-distribution (OOD) test result(s). The WTRU may be triggered by CRC failure(s) to apply the data performance monitoring.

The WTRU may be configured with one (e.g., a single) or more target data performance metrics (e.g., BER, BLER, and/or throughput), for example by the NW. A target data performance metric may be an application specific. The WTRU may be configured to alternate between AI/ML-based joint receiver functions and conventional legacy receiver functions. The WTRU may be configured to monitor the historical data performance.

The WTRU may be configured to generate the high-quality labels via performance monitoring allocations, for example to monitor the error between one or more of predicted symbols and the corresponding high-quality labels for AI/ML-based joint channel estimator and equalizer, and/or predicted LLRs and/or hard bits and the corresponding high-quality labels for AI/ML-based joint channel estimator, equalizer, and demodulator and/or AI/ML-based joint channel estimator and demodulator.

The WTRU may determine if there is data performance degradation, for example based on the outcome of the data performance monitoring. For example, the WTRU may determine that there is data performance degradation if one or more of the AI/ML-based joint receiver functions perform lower than pre-configured threshold, and/or the conventional legacy receiver functions achieve one or more of a better BER, BLER, and/or throughput performance than the AI/ML-based joint receiver functions.

The WTRU may determine that there is a data performance degradation. The WTRU may one or more of report performance degradation to NW (e.g., through UCI and/or MAC-CE), request updating/retraining the AI/ML model, and/or fallback to the legacy/non-AI/ML Rx function, for example if the WTRU determines there is data performance degradation:

The WTRU may be configured and/or triggered to apply an OOD detection mechanism, for example to identify whether the AI/ML model inputs belong to the same distribution as the data used in the AI/ML model training. The WTRU may be triggered to apply the OOD detection based on data performance monitoring. The WTRU may be triggered to apply the OOD detection based on CRC failure(s). The WTRU may be configured to use one or more of the received DMRS REs, data REs, CSI-RS REs and/or PRD REs in OOD detection.

The WTRU may determine an OOD detection result. The OOD detection test result may be binary (e.g., 0 or 1). 1 may correspond to out-of-distribution and 0 may correspond to in-distribution. The WTRU may continue to use AI/ML-based joint receiver functions, for example if the OOD test result is 0 (e.g., in-distribution).

An OOD event may occur, for example if the OOD test result is 1 (e.g., out-of-distribution). The WTRU may one or more of be configured to report the OOD event to the NW (e.g., through the UCI), fallback to the legacy/non-AI/ML receiver functions, request updating/retraining the AI/ML model, and/or be configured to apply the data performance monitoring, for example if a predetermined number N of OOD event occurs within a pre-configured period.

The OOD detection test result may be non-binary (e.g., floating-point number in [0,1]). The WTRU may be configured with one (e.g., a single) or more threshold(s) for OOD test results. The WTRU may continue to use AI/ML-based joint receiver functions, for example if an OOD test result is lower than any thresholds (e.g., in-distribution). The WTRU may be configured to report the test result event (e.g., to the NW through the UCI) and/or continue to use the same AI/ML model, for example if the OOD test result is higher than the first threshold but lower than the second threshold.

The WTRU may determine that an OOD event has occurred. The WTRU may determine that the OOD event has occurred, for example if the OOD test result is higher than any thresholds (e.g., out-of-distribution). The WTRU may one or more of be configured to report the OOD event to the NW (e.g., through the UCI), fallback to the legacy/non-AI/ML receiver functions, request updating/retraining the AI/ML model, and/or be configured to apply the data performance monitoring, for example if a predetermined number N of OOD event occurs within a pre-configured period.

1. A wireless transmit/receive unit (WTRU) comprising a processor, the processor configured to:
receive configuration information, the configuration information comprising an indication of a first receiver function training allocation type, a second receiver function training allocation type, or a third receiver function training allocation type, wherein the first receiver training allocation type is associated with user data allocations, the second receiver training allocation type is associated with pseudo-random data (PRD) allocations, and third receiver function training allocation type is associated with user data allocations and PRD allocations;
receive a downlink transmission that comprises at least one of data allocations or PRD allocations;
generate labels based on the received downlink transmission, wherein, when the configuration information comprises the first receiver function training allocation type, the labels are generated using the received data allocations, and wherein, when the configuration information comprises the second receiver function training allocation type, the labels are generated using the received PRD allocations, and wherein, when the configuration information comprises the third receiver function training allocation type, the labels are generated using both the received data allocations and the received PRD allocations; and
send a status message to a network, the status message comprising an indication of whether training is complete.

2. The WTRU of claim 1, wherein the processor is configured to:
send a request for online training of an artificial intelligence/machine learning (AI/ML)-based joint receiver function; and
report a capability associated with the WTRU, the capability associated with label generation.

3. The WTRU of claim 1, wherein the configuration information comprises the first receiver function training allocation type, and wherein the processor is configured to generate the labels by re-encoding decoded bits associated with the data allocations.

4. The WTRU of claim 3, wherein the processor is configured to determine if there is an error in a cyclic redundancy check (CRC), and wherein the processor is configured to generate the labels based on there being no error in the CRC.

5. The WTRU of claim 1, wherein the configuration information comprises the second receiver function training allocation type, and wherein the processor is configured to generate the labels with a PRD generator.

6. The WTRU of claim 5, wherein the processor is configured to:
receive a seed associated with the PRD allocations from the network; and
generate the labels with the PRD generator based on the seed associated with the PRD allocations.

7. The WTRU of claim 1, wherein the configuration information comprises the third receiver function training allocation type, and wherein the processor is configured to:
receive a seed associated with the PRD allocations from the network; and
generate the labels based on the seed associated with the PRD allocations and by re-encoding decoded bits associated with the data allocations.

8. The WTRU of claim 1, wherein the processor is configured to:
train an artificial intelligence/machine learning (AI/ML)-based joint receiver function based on the label; and
transmit the indication that training is complete to the network based on the training of the AI/ML-based joint receiver function.

9. The WTRU of claim 1, wherein the data allocations comprise data resource elements and the PRD allocations comprise PRD resource elements.

10. The WTRU of claim 9, the WTRU further comprising memory, wherein the processor is configured to store one or more of the data resource elements, the PRD resource elements, or the labels in the memory.

11. A method performed by a wireless transmit/receive unit (WTRU), the method comprising:
receiving configuration information, the configuration information comprising an indication of a first receiver function training allocation type, a second receiver function training allocation type, or a third receiver function training allocation type, wherein the first receiver training allocation type is associated with user data allocations, the second receiver training allocation type is associated with pseudo-random data (PRD) allocations, and third receiver function training allocation type is associated with user data allocations and PRD allocations;
receiving a downlink transmission that comprises at least one of data allocations or PRD allocations;
generating labels based on the received downlink transmission, wherein, when the configuration information comprises the first receiver function training allocation type, the labels are generated using the received data allocations, and wherein, when the configuration information comprises the second receiver function training allocation type, the labels are generated using the received PRD allocations, and wherein, when the configuration information comprises the third receiver function training allocation type, the labels are generated using both the received data allocations and the received PRD allocations; and
sending a status message to a network, the message comprising an indication of whether training is complete.

12. The method of claim 11, comprising:
sending a request for online training of an artificial intelligence/machine learning (AI/ML)-based joint receiver function; and
reporting a capability associated with the WTRU, the capability associated with label generation.

13. The method of claim 11, wherein the configuration information comprises the first receiver function training allocation type, and wherein the method comprises generating the labels by re-encoding decoded bits associated with the data allocations.

14. The method of claim 13, comprising:
determining if there is an error in a cyclic redundancy check (CRC); and
generating the labels based on there being no error in the CRC.

15. The method of claim 11, wherein the configuration information comprises the second receiver function training allocation type, and wherein the method comprises generating the labels with a PRD generator.

16. The method of claim 15, comprising:
receiving a seed associated with the PRD allocations from the network; and
generating the labels with the PRD generator based on the seed associated with the PRD allocations.

17. The method of claim 11, wherein the configuration information comprises the third receiver function training allocation type, and wherein the method comprises:
receiving a seed associated with the PRD allocations from the network; and
generating the labels based on the seed associated with the PRD allocations and by re-encoding decoded bits associated with the data allocations.

18. The method of claim 11, comprising:
training an artificial intelligence/machine learning (AI/ML)-based joint receiver function based on the label; and
transmitting the indication that training is complete to the network based on the training of the AI/ML-based joint receiver function.

19. The method of claim 11, wherein the data allocations comprise data resource elements and the PRD allocations comprise PRD resource elements.

20. The method of claim 19, comprising storing one or more of the data resource elements, the PRD resource elements, or the labels in a memory.
